(19) United States
(12) Patent Application Publication
(10) Pub. No.: US 2022/0162138 A1
(43) Pub. Date: May 26, 2022

(54) PROCESS FOR CLEAVING SULFUR-SULFUR AND SULFUR-HYDROGEN BONDS IN ORGANIC COMPOUNDS

(71) Applicant: McMaster University, Hamilton, CA (US)

(72) Inventors: Michael A. Brook, Ancaster, CA (US); Mengchen Liao, Hamilton, CA (US); Sijia Zheng, Hamilton (CA); Yang Chen, Ancaster (CA)

(73) Assignee: McMaster University, Hamilton, CA (US)

(21) Appl. No.: 17/594,126

(22) PCT Filed: Apr. 6, 2020
(86) PCT No.: PCT/CA2020/050455

§ 371 Date: Oct. 4, 2021

Related U.S. Application Data
(60) Provisional application No. 62/829,677, filed on Apr. 5, 2019.

(51) Int. Cl. C07B 45/06; C07B 63/00; C08J 11/28

(52) U.S. Cl. CPC C07B 45/06; C07B 63/00; C08J 2323/16; C08J 2321/00; C08J 11/28

(57) ABSTRACT

The present application provides a low-temperature process to reduce S—S and/or S—H bonds in organic compounds, including sulfur-cured elastomers, which for example, permits the de-crosslinking of the elastomer and recovery of organic polymers from inorganic constituents.

### FIELD

The present application relates to processes for cleaving S—S and S—H bonds in organic compounds. In particular, the present application includes process for breaking down and optionally recovering organic compounds containing S—S and S—H bonds, including organic polymers such as sulfur-crosslinked elastomers.

### BACKGROUND

The crosslinking by sulfur of unsaturated organic polymers constitutes an important technology for the formation of elastomers. The process, vulcanization of alkene-containing hydrocarbon polymers, reported by Goodyear in 1844,¹ is widespread. One sector that utilizes these technologies are rubbers destined for use in transportation, sales of automobile tires that use this process, for example, were expected to reach 3 billion units in 2019.² Vulcanization using sulfur involves radical processes that drive the crosslinking by mono- and oligosulfides of unsaturated organic polymeric chains.³ The products are very robust.

At the end of their useful lifetime, in the case of tires, some of the energy contained in the rubber is exploited as fuel in the cement industry, for instance, and some tires are turned into crumb and used as fillers,⁴ for example, in asphalt or cement, but a large fraction of tires constitute a form of waste that is difficult to dispose of.⁵ Tire fires at storage facilities are not uncommon and storage of tires can be accompanied by the leaching of their many constituents into the environment.

The sulfur-crosslinked rubbers used in automobile tires contain a wide variety of constituents, including (spent) catalysts for their formation, antioxidants, colorants, particulate reinforcing agents like carbon black and/or organosulfur-modified silica, and fibrous reinforcing agents including nylon cord and woven steel.⁶ However, the main component of the tire is typically a hydrocarbon-based, sulfur-cured, elastomer. There is a longstanding need to recover the organic materials from tires for sustainable reuse.

The difficulty associated with cleavage of sulfur crosslinks in organic elastomers compromises the ability to reuse or recycle rubber tires. The S—S bond strength is only 309 kJ mol⁻¹,⁷ so it is somewhat surprising that practicable processes for S—S cleavage in vulcanized tires have not been reported. Reuse strategies typically involve energetically intensive, relatively inefficient pyrolytic conversion into fuel gas, low grade carbon black and other materials. Alternative chemical approaches, for example, reactive reduction with LiAIH₄⁸⁻⁹ or amines¹⁰ have been proven only moderately successful.

Hydrosilanes are mild reducing agents. Transition metal-catalyzed processes like hydrolysis/alcoholysis,¹¹ C═C and C═O hydrosilylation;¹² and reductions of radicals¹³ and of carbocations¹⁴ are efficient. The Lewis acid-catalyzed (typically with B(C₆F₅)₃═BCF) reduction of carbonyls, ethers, silanols, alkoxysilanes (the Piers-Rubinsztajn reaction¹⁵⁻¹⁷) and benzylic, but not aliphatic, sulfides and thioacetals¹⁸ are convenient, mild and efficient processes for both organic transformations and silicone synthesis. The processes are in many cases thermodynamically driven by cleavage of weaker SiH bonds to form much stronger Si-heteroatom bonds.¹⁹ The reactions are normally easy to control, often work at room temperature, and the main experimental issues are associated with managing the co-products when they are flammable gases, including hydrogen or alkanes.

### SUMMARY

It has now been discovered that hydrosilanes may be used to cleave S—S and S—H bonds using Lewis acid-catalyzed processes, which permits the conversion of organic thiols, polysulfides and sulfur-crosslinked solid rubber tires (for example, in the form of bicycle inner tubes, solid tires or tire crumb), into silylated homogeneous solutions in good to excellent yield. In the case of automotive elastomers, the accompanying, unreactive solids, such as fillers, fiber and metal reinforcements, pigments, etc., are readily removed by centrifugation or filtration. The resulting products have been desilylated and re-oxidized to form new disulfide compounds, or in the case of polymeric compounds, new elastomers.

Accordingly, the present application includes a process for cleaving one or more S—S and/or S—H bonds in one or more organic compounds, comprising combining the one or more organic compounds with one or more hydrosilanes and a catalyst to form a reaction mixture and treating the reaction mixture under conditions to cleave one or more of the S—S and/or S—H bonds.

The present application also includes a method for de-crosslinking one or more sulfur-crosslinked elastomers comprising combining the one or more sulfur-crosslinked elastomers with one or more hydrosilanes and a catalyst to form a reaction mixture and treating the reaction mixture under conditions to de-crosslink the sulfur-crosslinked elastomers.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF THE DRAWINGS

The embodiments of the application will now be described in greater detail with reference to the attached drawings in which:

FIG. 1 shows the reductive silylation of A: organic sulfides and B: sulfur-based coupling agents in exemplary embodiments of the application.

FIG. 2 shows an exemplary benzyl disulfide reaction with BisH (compound 2) monitored by ¹H NMR.

FIG. 3 shows disulfide conversion in benzyl disulfide system versus [SiH]/[SS] using BisH (compound 2) in exemplary embodiments of the application.

FIG. 4 shows the benzyl tetrasulfide reaction with BisH (compound 2) monitored by ¹H NMR as a function of the initial [SiH]/[SSSS] ratio in exemplary embodiments of the application.

FIG. 5 shows organosulfide conversion in the reduction of the benzyl tetrasulfide system using BisH (compound 2) as a function of the initial [SiH]/[SSSS] in exemplary embodiments of the application.

FIG. 6 shows the differences in signal integration (¹H NMR) of [CH₂SSS], [CH₂SS] and [CH₂SSi] (top plot) and in alkoxy conversion (bottom plot) with reduction using BisH (compound 2) of a disulfide coupling agent, as a function of the initial [SiH]/[SiOR] using naphthalene as internal standard in exemplary embodiments of the application.

FIG. 7 shows the differences in signal integration (¹H NMR) of [CH₂SS], [CH₂SSS], [CH₂SSSS] and [CH₂SSi] (top plot) and in alkoxy conversion (bottom plot) with reduction using BisH (compound 2) of a tetrasulfide coupling agent system as a function of the initial [SiH]/[SiOR] using naphthalene as internal standard in exemplary embodiments of the application.

FIG. 8 shows the A: thermogravimetric analysis curves and B: differential thermal analysis curves of different exemplary rubber samples.

FIG. 9 shows the thermogravimetric analysis (TGA) of different exemplary rubber samples before (black line) and after (grey line) reduction.

FIG. 10 shows the thermogravimetric analysis (TGA) of A: exemplary tread (snow tire) and B: exemplary side wall (snow tire). Original starting rubber (black), residual bulks after reduction (grey), and residual powder collected after reduction (dashed line).

FIG. 11 shows A: coupon of inner tube rubber before (top, diameter: 16.93 mm, thickness: 0.82 mm) and after (diameter: 12.49 mm, thickness: 0.45 mm) the first exemplary reduction process; B: the exemplary starting material truck tread (8.30 cm wide×25.10 cm high); C: hydrosilylation mixture of powdered B; D: product polymeric oil solution after an exemplary reaction and filtration; E: recovered inorganic powder after filtration; F: steel wires removed from exemplary snow tire tread.

FIG. 12 shows the thermogravimetric analysis (TGA) of A: exemplary inner tube and B: exemplary truck tread samples with different scales (small=300 mg; large=2000 mg).

FIG. 13 shows the thermogravimetric analysis (TGA) of A: exemplary truck tread samples with (grey) or without (black) Soxhlet extraction. B: exemplary crumb-1 sample after multiple reduction steps.

FIG. 14 shows the ¹H NMR of exemplary recovered organic liquids.

FIG. 15 shows the gel permeation chromatography (GPC) data of exemplary recovered organic oil with two molecular populations.

FIG. 16 shows the exemplary reduction of inner tube samples after 18 h at 100° C. with different hydrosilanes, A: Me₃Si(OSiMeH)ₙSiMe₃ 19 and B: HMe₂SiOSiMe₂H 20 (TetraH).

FIG. 17 shows reductive silylation, cleavage of SiS bonds and oxidative coupling production of elastomers crosslinked by disulfides or radicals forming elastomers from alkene-containing oils in exemplary embodiments of the application.

FIG. 18 shows ¹H NMR showing loss of silicone groups from the exemplary organic polymers after utilizing TBAF.

FIG. 19 shows the exemplary crosslinked elastomer 23, formed by iodine reoxidation of the thiols in 22, swollen in 10 ml hexane after 1 h sonication.

FIG. 20 shows A: removal of the right front tire from a toy car; B: a silicone mold of the tire; C: the organic oil prepared by reduction of truck tire tread with PentaH; D: silicone mold filled with 0.707 g recovered polymeric oil+1 wt % BPO+0.3010 g residual solid; E: new tire after curing; F: tire replacement; G: the residual solid during the preparation of polymeric oil could be included in the pre-elastomer formulation; H: close up showing: i) the original tire, ii) tire made without additional inorganic excipients, and iii) tire including inorganic excipients in exemplary embodiments of the application.

FIG. 21 shows A: rubber contaminated steel, recovered from tire shredding; B: steel after chemical treatment; C: post-treatment steel after mechanical grinding; D: contaminated steel after heating in 100° C. toluene for 18 h, and a simple grinding process (no chemical cleaning); E: steel recovered after a second use of the reducing solution in exemplary embodiments of the application.

FIG. 22 shows photographs of extracts of rubber treated thermally with and without the presence of a hydrosilicone in exemplary embodiments of the application.

FIG. 23 shows infrared spectra of rubber treated thermally with and without the presence of a hydrosilicone in exemplary embodiments of the application.

### DETAILED DESCRIPTION OF THE APPLICATION

### 1. Definitions

Unless otherwise indicated, the definitions and embodiments described in this and other sections are intended to be applicable to all embodiments and aspects of the present application herein described for which they are suitable as would be understood by a person skilled in the art.

The present application refers to a number of chemical terms and abbreviations used by those skilled in the art. Nevertheless, definitions of selected terms are provided for clarity and consistency.

In understanding the scope of the present application, the term “comprising” and its derivatives, as used herein, are intended to be inclusive or open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

As used herein, the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application, the singular forms “a”, “an” and “the” include plural references unless the content clearly dictates otherwise. For example, an embodiment including “a catalyst” should be understood to present certain aspects with one catalyst or two or more catalysts. In embodiments comprising an “additional” or “second” component, such as an additional or second catalyst, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “alkyl” as used herein, whether it is used alone or as part of another group, refers to straight or branched chain, saturated alkyl groups. The number of carbon atoms that are possible in the referenced alkyl group are indicated by the prefix “Cₙ₁₋ₙ₂”. For example, the term C₁₋₁₀ alkyl means an alkyl group having 1, 2, 3, 4, 5, 6, 7, 8, 9 or 10 carbon atoms.

The term “alkoxy” as used herein, whether it is used alone or as part of another group, refers to straight or branched chain, saturated alkyl-O groups. The number of carbon atoms that are possible in the referenced alkoxy group are indicated by the prefix “Cₙ₁₋ₙ₂”. For example, the term C₁₋₁₀ alkoxy means an alkoxy group having 1, 2, 3, 4, 5, 6, 7, 8, 9 or 10 carbon atoms.

The term “aryl” as used herein, whether it is used alone or as part of another group, refers to cyclic groups containing from 6 to 10 carbon atoms and at least one aromatic ring. In an embodiment of the application, the aryl group contains from 6, 9 or 10 carbon atoms, such as phenyl, indanyl or naphthyl.

The term “C₁₋₆alkoxy-substituted” as used herein means that one hydrogen atom on the referenced group is substituted with a C₁₋₆alkoxy group.

The term “fluoro-substituted” as used herein means one or more, including all, of the hydrogen atoms on the referenced group is substituted with a fluorine atom.

The term “hydrosilane” as used herein refers to a compound containing at least one Si—H bond.

The term “linear silicone” as used herein in reference to a substituent group on a molecule means a group having the chemical formula

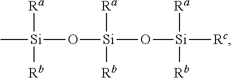

where

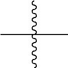

represents the point of attachment to the molecule, each R^{a}, R^{b} and R^{c} is independently C₁₋₆alkyl or aryl (typically methyl or phenyl) and p represents the number of repeating OSiR^{a}R^{b} groups (typically 0-100). It is common for R^{a}, R^{b} and R^{c} to be the same.

The term “branched silicone” as used in reference to a substituent group on a molecule means a group having the chemical formula

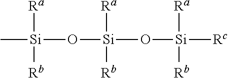

in which one or more of the R^{a} or R^{b} groups are —(OSiR^{a}R^{b})_{q}—, resulting in a branched-type structure, and the other R^{a} or R^{b} groups, as well as R^{c} are independently C₁₋₆alkyl or aryl (typically methyl or phenyl), p represents the number of repeating OSiR^{a}Rb groups (typically 1-100) and

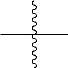

represents the point of attachment to the molecule. It is common for R^{a}, R^{b} and R^{c} to be the same.

The terms “elastomer” or “rubber” as used herein, are used interchangeably refers to polymers crosslinked using at least one disulfide bond.

The term “thiol”, as used herein, refers to a compound containing an S—H bond.

The term “organic compounds” as used herein refers to carbon-based compounds comprising at least one S—S and/or S—H bonds and includes polymeric and non-polymers compounds and optionally comprised other heteroatoms, such as but not limited to O, Si, Ti and/or N

The term “organopolysulfide” as used herein, refers to a compound containing one or more sulfur-sulfur bonds, including but not limited to, a disulfide and an oligosulfide.

### II. Processes of the Application

The present application includes a process for cleaving one or more S—S and/or S—H bonds in one or more organic compounds, comprising combining the one or more organic compounds with one or more hydrosilanes and a catalyst to form a reaction mixture and treating the reaction mixture under conditions to cleave one or more of the S—S and/or S—H bonds.

The present application also includes a process for cleaving one or more S—S and/or S—H bonds in one or more organic compounds, comprising combining the one or more organic compounds with one or more hydrosilanes to form a reaction mixture and treating the reaction mixture under conditions to cleave one or more of the S—S and/or S—H bonds.

In some embodiments, the conditions to cleave the one or more of the S—S and/or S—H bonds comprises a reaction temperature of about 20° C. to about 130° C., preferably about 20° C. to about 100° C. In some embodiments, the conditions to cleave the one or more of the S—S and/or S—H bonds comprises a reaction temperature of about 40° C. to about 80° C. In some embodiments, the conditions to cleave the one or more of the S—S and/or S—H bonds comprises a reaction temperature of below about 80° C.

In some embodiments, the one or more organic compounds are selected from one or more sulfur-containing silyl coupling agents.

In some embodiments, the one or more sulfur-containing silyl coupling agents are selected from compounds of Formula I:

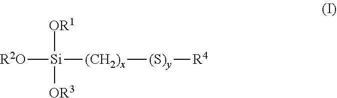

wherein
R¹, R² and R³ are independently selected from C₁₋₁₀alkyl, C₂₋₁₀alkenyl, C₁₋₄alkylenearyl, aryl, linear silicones and branched silicones;
R⁴ is selected from H and

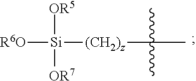

R⁵, R⁶ and R⁷ are independently selected from C₁₋₁₀alkyl, C₂₋₁₀alkenyl, C₁₋₄alkylenearyl, aryl, linear silicones and branched silicones;
x and z are independently 1, 2, 3, 4, 5 or 6; and
y is 1, 2, 3, 4, 5, 6, 7 or 8, provided that when y is 1, R⁴ is H.

In some embodiments, R¹, R² and R³ are independently selected from C₁₋₆alkyl, C₂₋₆alkenyl, C₁₋₂alkylenearyl, aryl, linear silicones and branched silicones. In some embodiments, R¹, R² and R³ are independently selected from C₁₋₄alkyl, C₂₋₄alkenyl, CH₂aryl, aryl, linear silicones and branched silicones. In some embodiments, R¹, R² and R³ are the same and are CH₃, CH₃CH₂, (CH₃)₂CH, CH₃CH₂CH₂, CH₂═CHCH₂ or PhCH₂. In some embodiments, R¹, R² and R³ are the same and are CH₃CH₂.

In some embodiments, R⁴ is H.

In some embodiments, R⁴ is

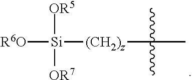

In some embodiments, R⁵, R⁶ and R⁷ are independently selected from C₁₋₆alkyl, C₂₋₆alkenyl, C₁₋₂alkylenearyl, aryl, linear silicones and branched silicones. In some embodiments, R⁵, R⁶ and R⁷ are independently selected from C₁₋₄alkyl, C₂₋₆alkenyl, CH₂aryl, aryl, linear silicones and branched silicones. In some embodiments, R⁵, R⁶ and R⁷ are the same and are CH₃, CH₃CH₂, (CH₃)₂CH, CH₃CH₂CH₂, CH₂═CHCH₂ or PhCH₂. In some embodiments, R¹, R² and R³ are the same and are CH₃CH₂.

In some embodiments, x and z are independently 1, 2, 3 or 4. In some embodiments, x and z are independently 3 or 4. In some embodiments, x and z are both 3 or 4. In some embodiments, x and z are both 3.

In some embodiments, the one or more compounds of Formula I are selected from:

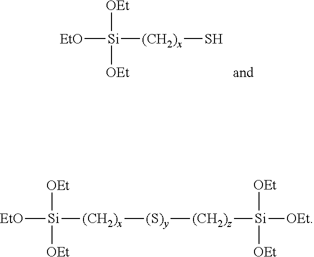

wherein each x and z is independently 1, 2, 3 or 4, suitably 3 and y is selected from 2, 3, 4, 5 and 6.

In some embodiments, the one or more organic compounds are one or more organopolysulfides.

In some embodiments, the one or more organopolysulfides are selected from one or more sulfur-cured elastomers.

In some embodiments, the one or more sulfur-cured elastomers is a crosslinked polyolefin.

In some embodiments, the one or more sulfur-cured elastomers is a polyisobutylene, polyisoprene, natural rubber or polybutadiene, or a copolymer thereof, such as styrene-butadiene.

In some embodiments, the one or more hydrosilanes are selected from compounds of Formula II:

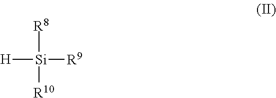

wherein
R⁸, R⁹ and R¹⁰ are independently selected from H, halo, C₁₋₁₀alkyl, C₁₋₁₀alkoxy, aryl, C₁₋₂alkylenearyl, C₁₋₆alkoxy-substituted C₁₋₁₀alkyl, C₁₋₆alkoxy-substituted aryl, linear silicones and branched silicones, provided that at least one of R⁸, R⁹ and R¹⁰ is other than H.

In some embodiments, R⁸, R⁹ and R¹⁰ are independently selected from H, Cl, C₁₋₆alkyl, C₁₋₆alkoxy, aryl, C₁alkylenearyl, C₁₋₄alkoxy-substituted C₁₋₆alkyl, C₁₋₄alkoxy-substituted aryl, linear silicones and branched silicones, provided that at least one of R⁸, R⁹ and R¹⁰ is other than H. In some embodiments, zero or one of R⁸, R⁹ and R¹⁰ are independently linear silicones or branched silicones and the remainder of R⁸, R⁹ and R¹⁰ are, independently selected from H, Cl, C₁₋₄alkyl, C₁₋₄alkoxy, phenyl, CH₂phenyl, C₁₋₂alkoxy-substituted C₁₋₄alkyl and C₁₋₂alkoxy-substituted aryl, provided that at least one of R⁸, R⁹ and R¹⁰ is other than H. In some embodiments, the compound of Formula II is selected from, PhSiH₃, PhMeSiH₂, Ph₂SiH₂, Ph₂MeSiH, Ph₃SiH, H₂SiCl₂, HSiCl₃, MeSiH₃, MeSiHCl₂, Me₂SiH₂, Me₃SiH, Et₂SiH₂, MeHSi(OMe)₂, HSi(OMe)₃, Et₂MeSiH, Et₃SiH and HSi(OEt)₃, and mixtures thereof. In some embodiments, the compound of Formula II is selected from, PhSiH₃, PhMeSiH₂ and Ph₂SiH₂, and mixtures thereof.

In some embodiments, the one or more hydrosilanes are selected from compounds of Formula III

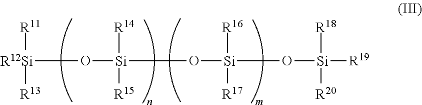

wherein
R¹¹, R¹², R¹³, R¹⁴, R¹⁵, R¹⁶, R¹⁷, R¹⁸, R¹⁹ and R²⁰ are independently selected from H, halo, C₁₋₁₀alkyl, C₁₋₁₀alkoxy, aryl, C₁₋₂alkylenearyl, fluoro-substituted C₁₋₁₀alkyl, C₁₋₆alkoxy-substituted C₁₋₁₀alkyl, fluoro-substituted aryl and C₁₋₆alkoxy-substituted aryl, provided that
R¹² is H, and R¹¹, R¹³, R¹⁴, R¹⁵, R¹⁶, R¹⁷, R¹⁸, R¹⁹ and R²⁰ are other than H,
R¹² and R¹⁹ are H, and R¹¹, R¹³, R¹⁴, R¹⁵, R¹⁶, R¹⁷, R¹⁸ and R²⁰ are other than H, or
R¹⁴ is H and R¹¹, R¹³, R¹⁵, R¹⁶, R¹⁷, R¹⁸ and R²⁰ are other than H, or
R¹⁶ is H and R¹¹, R¹³, R¹⁴, R¹⁵, R¹⁷, R¹⁸ and R²⁰ are other than H; and
n and m are independently 0, 2, 3, 4, 5, 6, 7, 8, 9 or 10-1000. In some embodiments n and m are independently 0, 2, 3, 4, 5, 6, 7, 8, 9 or 10.

In some embodiments, R¹¹, R¹², R¹³, R¹⁴, R¹⁵, R¹⁶, R¹⁷, R¹⁸, R¹⁹ and R²⁰ are independently selected from H, Cl, C₁₋₆alkyl, C₁₋₆alkoxy, phenyl, C₁₋₂alkylenephenyl, fluoro-substituted C₁₋₆alkyl, C₁₋₄alkoxy-substituted C₁₋₆alkyl, fluoro-substituted phenyl and C₁₋₄alkoxy-substituted aryl, with the above-noted provisos.

In some embodiments, R¹¹, R¹², R¹³, R¹⁴, R¹⁵, R¹⁶, R¹⁷, R¹⁸, R¹⁹ and R²⁰ are independently selected from H, C₁₋₄alkyl, phenyl, CH₂phenyl, fluoro-substituted C₁₋₄alkyl, C₁₋₄alkoxy-substituted C₁₋₄alkyl, fluoro-substituted phenyl and C₁₋₄alkoxy-substituted aryl, with the above-noted provisos.

In some embodiments, the compounds of Formula III are selected from one or more of

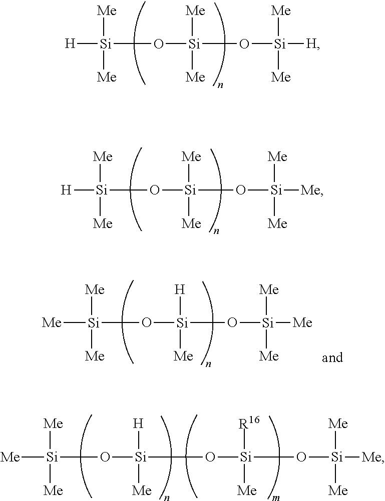

wherein R¹⁶ is C₁₋₆alkyl or aryl, each n is independently 0, 1, 2,3, 4, 5 or 6 and m is 0, 1, 2, 3, 4, 5 or 6.

In some embodiments, the hydrosilane is

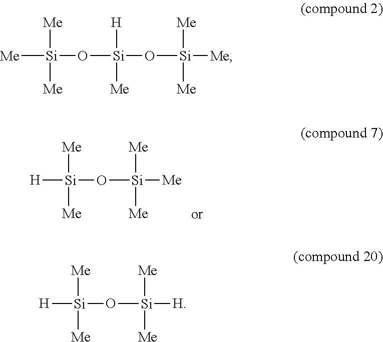

In some embodiments, the one or more hydrosilanes are cyclic hydrosilanes, such as cyclic siloxanes, including, but not limited to tetramethylcyclotetrasiloxane and pentamethylcyclopentasiloxane.

In some embodiments, the S—S and/or S—H bonds in the one or more organic compounds are reductively cleaved.

In some embodiments, one or more silyl thiol ethers are produced in a process of the application.

In some embodiments, the one or more hydrosilanes are present in an amount from about 2:1 to about 5:1 equivalents relative to the S—S and/or S—H bond content in the one or more organic compounds.

In some embodiments, the catalyst is a Lewis acid. In some embodiments, the Lewis acid catalyst comprises boron. In some embodiments, the catalyst is B(C₆F₅)₃.

In some embodiments, the catalyst is present in an amount of about 0.01 mol % to about 5 mol %.

The present application also includes a method for de-crosslinking one or more sulfur-crosslinked elastomers comprising combining the one or more sulfur-crosslinked elastomers with one or more hydrosilanes and a catalyst to form a reaction mixture and treating the reaction mixture under conditions to decrosslink the sulfur-crosslinked elastomers.

The present application also includes a method for de-crosslinking one or more sulfur-crosslinked elastomers comprising combining the one or more sulfur-crosslinked elastomers with one or more hydrosilanes to form a reaction mixture and treating the reaction mixture under conditions to decrosslink the sulfur-crosslinked elastomers.

In some embodiments, the one or more sulfur-crosslinked elastomers are rubbers used in tires. In some embodiments, the tires are automotive tires. In some embodiments, the tires are industrial tires such as truck tires, agricultural tires or mining tires. In some embodiments the rubbers are bicycle inner tubes.

In some embodiments, the elastomers or rubbers are treated prior to combining with the one or more hydrosilanes, for example to form into a crumb and/or to extract extractible components with solvents such as acetone.

The products produced by the process of the application are silylated sulfur-containing compounds, including silylated sulfur-containing polymers. In some embodiments, these silylated sulfur-containing compounds are separated from solid or inorganic materials that may have been present in the one or more organic compounds. In some embodiments, the solid or inorganic materials include, but are not limited to unreactive solids such as fillers, fiber and metal reinforcements, and pigments. In some embodiments, the solid or inorganic materials are separated by filtration and/or centrifugation.

In some embodiments, the products produced by the process of the application are silylated sulfur-containing organic polymers and are in the form of oils.

In some embodiments, the silylated sulfur-containing compounds are desilylated, for example by treatment with fluoride, to provide the corresponding thiols, which, in some embodiments, are re-oxidized to provide other S—S containing compounds.

In some embodiments of the application, provided herein are sulfur-containing elastomers produced by desilylation and reoxidation of the silicones produced by the reductive silylation process disclosed herein. In an embodiment, after removal of inorganic materials and desilylation of the reduced organic product with fluoride, the resulting thiols may be reoxidized to generate new elastomers.

The present application also includes de-crosslinked sulfur-cured elastomers prepared using the process of the present application.

The following non-limiting examples are illustrative of the present application. As is apparent to those skilled in the art, many of the details of the examples may be changed while still practicing the methods, compositions and kits described herein.

### EXAMPLES

The following non-limiting examples are illustrative of the present application:

### Example 1. Reduction of Model Oligosulfides

Experimental Procedure

Materials: Bis(trimethylsiloxy)methylsilane (BisH), bis(triethoxysilylpropyl)disulfide (90%), bis(triethoxysilylpropyl)tetrasulfide and pentamethyldisiloxane (PentaH) were purchased from Gelest and used after drying over molecular sieves overnight. Dibenzyl disulfide and benzyl bromide were obtained from Sigma Aldrich and used as received. Sodium tetrasulfide was purchased from Dojindo. B(C₆F₅)₃ (BCF) was prepared by Grignard reaction following a literature procedure.²⁰ Naphthalene (internal standard) was purchased from Fisher. Toluene (solvent) received from Caledon (HPLC grade) was dried over activated alumina before use. Deuterated NMR solvents were obtained from Cambridge Isotope Laboratories. All glass apparatus were dried overnight at 120° C. and cooled under a dry nitrogen atmosphere for 30 min prior to use.

Methods: ¹H, ¹³C and ²⁹Si NMR spectra were recorded on a BrukerAvance 600 MHz nuclear magnetic resonance spectrometer using deuterated solvents chloroform-d and actone-d₆. For ²⁹Si NMR, chromium(III) acetylacetonate was used as paramagnetic relaxation agent.

GC-MS analyses were performed using an Agilent 6890N gas chromatograph (Santa Clara, Calif., USA), equipped with a DB-17ht column (30 m×0.25 mm i.d.×0.15 μm film, J&W Scientific) and a retention gap (deactivated fused silica, 5 m×0.53 mm i.d.), and coupled to an Agilent 5973 MSD single quadruple mass spectrometer. One microliter of sample was injected using an Agilent 7683 autosampler in splitless mode. The injector temperature was 250° C. and carrier gas (helium) flow was 1.1 mL/min. The transfer line was 280° C. and the MS source temperature was 230° C. The column temperature started at 50° C. and was increased to 300° C. at 8° C./min, then held at 300° C. for 15 min to give a total run time of 46.25 min. Full scan mass spectra between m/z 50 and 800 mass units were acquired after a solvent delay of 8 min.

LC-MS analyses were undertaken using an Agilent Technologies 1200 LC coupled to an Agilent 6550 QTOF mass spectrometer. An injection volume of 2 μL was separated on a Phenomenex Luna C18(2) (150 mm×2.0 mm, 3 μm) column with 100 Å pore size (Phenomenex, Calif., USA). The mobile phases were LC-MS-grade 45/55 water/methanol with 0.5% acetic acid (A) and methanol with 0.5% acetic acid (B) at a flow rate of 300 μL/min. The column temperature was maintained at 40° C., and the autosampler storage tray was set at 10° C. The mobile phase gradient eluted isocratically with 10% B for 1.0 min followed by a gradient to 100% B over 17 min. The gradient was maintained at 100% B for 2 min and decreased to 10% B over 0.1 min. The gradient was then followed by a 5 min re-equilibration prior to the next injection. The total time for an HPLC run was 25 min. The MS parameters (for LC-MS) chosen were as follows: ESI, gas temperature at 225° C., drying gas at 13 L/min, nebulizer pressure at 20 psi, sheath gas temperature at 400° C., sheath gas flow at 12 L/min, VCap at 3500 V, Nozzle Voltage at 1000 V, fragmenter at 375 V, and October 1 RF Vpp at 750 V. The data were acquired in electrospray positive mode from m/z 50 to 1000 at a scan rate of 1.5 Hz. The mass was auto recalibrated using reference lock mass from Agilent ESI-T Tuning Mix (for Ion Trap).

Thermogravimetric analysis (TGA) analysis according to ASTM D 6370-99 (American Society for Testing and Materials) was carried out to measure the organic polymer, carbon black content and inorganic residue of the component. A small amount of test sample (2 to 5 mg) was placed into the alumina pan of the calibrated Thermogravimetric Analyzer (Mettler Toledo TGA/DSC 3+). A 100 cm³ min-¹ argon purge was applied and the furnace was heated from 50° C. to 560° C. at 10° C. min-¹. Then, the furnace was cooled to 300° C. and the purge gas was changed to air at 100 cm³ min-¹. The temperature was allowed to equilibrate for 2 min before the furnace was heated to 800° C. at 10° C. min⁻¹.

Stock solutions were prepared as follows:

B(C₆F₅)₃: BCF was dissolved in dry toluene to prepare a stock solution (50 mg mL⁻¹).

Bis(triethoxysilylpropyl)disulfide: naphthalene (0.056 g, 0.437 mmol) was added to bis(triethoxysilylpropyl)disulfide (2.21 mL, 2.27 g, 4.77 mmol) in a dried 20.0 mL glass vial (naphthalene 128.17 g mol-1, density of disulfide coupling agent: 1.025 g mL-1, density of tetrasulfide coupling agent: 1.095 g mL-1).

Bis(triethoxysilylpropyl)tetrasulfide: naphthalene (0.301 g, 2.35 mmol) was added to bis(triethoxysilylpropyl)tetrasulfide (11.77 mL, 12.89 g, 23.91 mmol) in a dried 20.0 mL glass vial).

Naphthalene in chloroform-d: solid naphthalene (4 mg, 0.031 mmol) was added to chloroform-d (2 mL, 3.0 g, 24.92 mmol) in a dried 20.0 mL glass vial.

(a) Preparation of Dibenzyl Tetrasulfide

To a pre-dried 200 mL round-bottomed flask purged with dry N₂ were added sodium tetrasulfide (0.098 g, 0.562 mmol), benzyl bromide (0.209 g, 1.22 mmol) and dry THE (50 mL, 44.45 g, 0.616 mol) as solvent. The mixture was stirred for 23 d and collected by vacuum filtration. The mixture was purified using column chromatography; the low polarity impurity (S₈) was removed using hexanes, after which the elution solvent was switched to dichloromethane, to give a yield of 77% (137 mg, based on the different sulfides found in the product, Note: it was not possible to detect tetrasulfide or higher polysulfide linkages in the GC-MS, which may be due to thermal degradation of polysulfide bond (when n>3), according to Stensaas et al. (2008)²¹

¹H NMR (600 MHz, acetone-d₆): δ 3.72 (s, 0.11H), 4.11 (s, 2.02H), 4.24 (s, 1.20H), 4.30 (s, 0.67H), 7.28-7.40 (m, 9.21H) ppm. ¹³C NMR (600 MHz, acetone-d₆): δ 29.85, 43.55, 43.99, 44.54, 128.36, 129.42, 130.33, 137.54, 137.80 ppm.

GC-MS C₁₄H₁₄S₂, MW:246: [M⁺-1]=65.2 (18), 77.2 (8), 91.1 (90), 121.1 (5), 181.2 (18), 246.1 (20); S₈, MW:256: [M⁺-1]=64.1 (100), 77.1 (7), 91.1 (66), 127.9 (60), 160.0 (66), 191.9 (53), 207.1 (5), 223.9 (7), 255.8 (98), 315.1 (5). C₁₄H₁₄S₃, MW:278: [M⁺-1]=65.2 (13), 77.1 (3), 91.2 (100), 123.1 (3), 181.2 (2), 213.1 (56), 278.1 (13).

(b) Dibenzyl Disulfide Reduction Using Bis(Trimethylsiloxy)Methylsilane ([SiH]/[SS]=2:1, Molar Ratio Between Hydrosilane and Disulfide)

To a pre-dried 200 mL round-bottomed flask purged with dry N₂ gas, dibenzyl disulfide (0.50 g, 2.04 mmol) and bis(trimethylsiloxy)methylsilane (0.91 g, 4.09 mmol) were added together with dry DCM (3.81 g, 44.86 mmol) as solvent. Freshly prepared B(C₆F₅)₃ stock solution was added (0.167 mL, 0.0326 mmol) after 5 min stirring. The total reaction time was 3 h, then the reaction was quenched by adding neutral alumina. The reaction was conducted under identical reaction conditions only changing the ratio of hydrosilane to disulfide [SiH]/[SS] (Table 1) to establish relative reactivity of functional groups. Conversion in the reaction was shown by peak area of the hydrogens on the carbon adjacent to the disulfide bond (—CH₂SS) in ¹H NMR which was plotted against different ratios of hydrosilane (SiH) to disulfide. Analogous techniques were used to follow the reduction of the tetrasulfide.

TABLE 1
Reactivity comparison using dibenzyl sulfide and
bis(trimethylsiloxy)methylsilane

| | | | | B(C₆F₅)₃ |
|---|---|---|---|---|
| Ratio [SiH]/[SS] | disulfide (g) | BisH (g) | DCM (g) | (mL)^{a} |
| 0.25 | 0.50 | 0.12 | 1.68 | 0.021 |
| 0.5 | 0.50 | 0.24 | 2.05 | 0.042 |
| 1 | 0.50 | 0.46 | 2.59 | 0.084 |
| 1.5 | 0.50 | 0.68 | 3.20 | 0.125 |
| 2 | 0.50 | 0.91 | 3.81 | 0.167 |

^{a}100 mg mL⁻¹ B(C₆F₅)₃ stock solution

Dibenzyl tetrasulfide reduction using bis(trimethylsiloxy)methylsilane ([SiH]/[SS]=1:1): To a dried glass NMR tube (7×5 mm) purged with dry N₂ gas, dibenzyl tetrasulfide (0.055 g, 0.185 mmol, a mix of oligosulfides, see above) and bis(trimethylsiloxy)methylsilane (0.048 g, 0.216 mmol) were added together with chloroform-d stock solution (0.6 mL). Freshly prepared B(C₆F₅)₃ stock solution was added (0.023 mL, 0.0045 mmol) after 5 min sonication. Titrations were performed by adding bis(trimethylsiloxy)methylsilane (0.048 g, 0.216 mmol) and B(C₆F₅)₃ stock solution (0.023 mL, 0.0045 mmol) in aliquots portion by portion with 3 h time interval between additions.

(c) Complete Reduction of Bis(Triethoxysilylpropyl)Disulfide Using Bis(Trimethylsiloxy)Methylsilane ([SiH]/[SiOR]=8:6, Molar Ratio Between Hydrosilane and Alkoxysilane)

To a pre-dried 200 mL round bottle flask purged with dry N₂ gas, bis(triethoxysilylpropyl)disulfide stock solution (0.50 g, 1.05 mmol) and bis(trimethylsiloxy)methylsilane (1.90 g, 8.54 mmol) were added together with dry toluene (0.730 g, 7.92 mmol) as solvent. Freshly prepared B(C₆F₅)₃ stock solution was added (0.345 mL, 0.067 mmol) after 5 minutes stirring. The total reaction time was 3 h, then the reaction was quenched by adding neutral alumina; yield was 91.9%.

¹H NMR (600 MHz, chloroform-d): δ 0.03-0.12 (m, 604H), 0.29-0.30 (m, 20H), 0.37 (s, 2H), 0.66-0.69 (m, 14H), 1.17-1.18 (m, 5H), 1.55 (s, 10H), 1.69-1.72 (m, 13H), 2.36 (s, 84H), 2.50-2.54 (m, 13H), 3.78-3.80 (m, 1H), 7.48-7.49 (dd, J=7.49 Hz, 1H), 7.84-7.86 (dd, J=7.85 Hz, 1H) ppm; ¹³C NMR (600 MHz, chloroform-d): δ −1.86, 2.06, 5.16, 14.53, 21.81, 26.55, 30.07, 77.36, 126.16, 128.58, 138.21 ppm; ²⁹Si NMR (600 MHz, chloroform-d, trace Cr(acac)₃): δ 9.40-9.53 (m, 4Si), 7.45-7.62 (m, 16Si), −30.67 (s, 1Si), −54.49 (s, 2Si), −66.16−(−)65.90 (m, 1Si) ppm.

(d) Complete Reduction of Bis(Triethoxysilylpropyl)Tetrasulfide Using Bis(Trimethylsiloxy)Methylsilane ([SiH]/[SiOR]=12:6, Molar Ratio Between Hydrosilane and Alkoxysilane)

To a pre-dried 200 mL round bottle flask purged with dry N₂ gas were added bis(triethoxysilylpropyl)tetrasulfide stock solution (0.50 g, 0.93 mmol) and bis(trimethylsiloxy)methylsilane (2.48 g, 11.1 mmol) together with dry toluene (0.90 g, 9.77 mmol) as solvent. Freshly prepared B(C₆F₅)₃ stock solution was added (0.456 mL, 0.089 mmol) after 5 minutes stirring. The total reaction time was 3 hours, then the reaction was quenched by adding neutral alumina; yield was 59.0%.

¹H NMR (600 MHz, chloroform-d): δ 0.03-0.15 (m, 964H), 0.29-0.30 (d, J=0.29 Hz, 13H), 0.37 (s, 35H), 0.67-0.69 (m, 14H), 1.70-1.73 (m, 14H), 2.36 (s, 141H), 2.51-2.54 (m, 14H), 7.48-7.49 (dd, J=7.48 Hz, 1H), 7.84-7.86 (dd, J=7.85 Hz, 1H) ppm; ¹³C NMR (600 MHz, chloroform-d): δ −1.86, 2.02, 5.16, 14.43, 21.81, 26.67, 28.29, 30.08, 77.36, 125.66, 128.58, 129.39, 138.21 ppm; ²⁹Si NMR (600 MHz, chloroform-d, trace Cr(acac)₃): δ 9.42-9.60 (m, 17Si), 7.46-7.64 (m, 25Si), −30.66 (s, 1Si), −32.92 (s, 4Si), −66.22−(−) 65.88 (m, 6Si), −71.05 (s, 0.12 Si) ppm.

(e) Bis(Triethoxysilylpropyl)Disulfide Using Bis(Trimethylsiloxy)Methylsilane ([SiH]/[SiOR]=3:6)

As bis(triethoxysilylpropyl)disulfide is a complex mixture of oligosulfides, calculations for the concentration of S—S groups in the monomer were adjusted according to GC-MS data showing that the major constituent was the disulfide (Table 2).

TABLE 2
GC-MS for bis[3-(triethoxysilyl)propyl]disulfide (disulfide coupling agent)

| Elution time | | | Relative ratio |
|---|---|---|---|
| (min) | M.W (g mol⁻¹) | Structures | (%) |
| 23.6 | 474 | 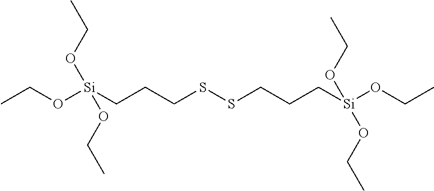 [SMILES: CCO[Si](CCCSSCCC[Si](OCC)(OCC)OCC)(OCC)OCC] | 89.3 |
| 25.8 | 506 | 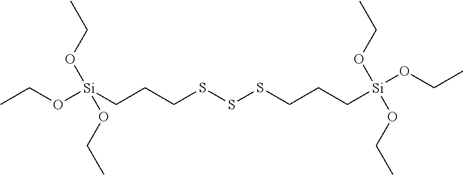 [SMILES: CCO[Si](CCCSSSCCC[Si](OCC)(OCC)OCC)(OCC)OCC] | 10.7 |

To a pre-dried 200 mL round bottle flask purged with dry N₂ gas were added bis(triethoxysilylpropyl)disulfide stock solution (1.015 g, 214 mmol) and bis(trimethylsiloxy)methylsilane (1.431 g, 6.43 mmol) together with dry toluene (0.730 g, 7.92 mmol) as solvent. Freshly prepared B(C₆F₅)₃ stock solution was added (0.259 mL, 0.051 mmol) after 5 min stirring. The total reaction time is 3 h, then the reaction was quenched by adding neutral alumina. The product was collected under reduced pressure. The reaction was conducted under identical reaction conditions only changing the ratio of hydrosilane against disulfide [SiH]/[SS] (Table 3).

TABLE 3
Reactivity comparison using bis[3-(triethoxysilyl)propyl]disulfide
and bis(trimethylsiloxy)methylsilane

| | | | | B(C₆F₅)₃ |
|---|---|---|---|---|
| Ratio [SiH]/[SS] | disulfide (g) | BisH (g) | Toluene (g) | (mL)^{a} |
| 1 | 0.50 | 0.24 | 0.22 | 0.135^{b} |
| 2 | 1.01 | 0.99 | 0.58 | 0.173 |
| 3 | 1.01 | 1.43 | 0.73 | 0.259 |
| 4 | 0.50 | 0.95 | 0.43 | 0.173 |
| 5 | 0.50 | 1.17 | 0.51 | 0.216 |
| 6 | 0.50 | 1.42 | 0.57 | 0.258 |
| 7 | 0.50 | 1.66 | 0.65 | 0.302 |
| 8 | 0.50 | 1.90 | 0.73 | 0.345 |

^{a}100 mg mL⁻¹ B(C₆F₅)₃ stock solution
^{b}only at this point [BCF]/[SiH] = 2.5 mol %, under which [SiH] unable to be consumed completely

(f) Bis(Triethoxysilylpropyl)Tetrasulfide Using Bis(Trimethylsiloxy)Methylsilane ([SiH]/[SiOR]=3:6)

As bis(triethoxysilylpropyl)tetrasulfide is a complex mixture of oligosulfides, calculations for the concentration of S—S groups in the monomer were adjusted according to LS-MS data showing that the major constituent was the trisulfide (Table 4).

TABLE 4
LC-MS for bis[3-(triethoxysilyl)propyl]tetrasulfide (tetrasulfide coupling agent)

| Elution time | | | Relative ratio |
|---|---|---|---|
| (min) | M.W (g mol⁻¹) | Structures | (%) |
| 18.07 | 474 | 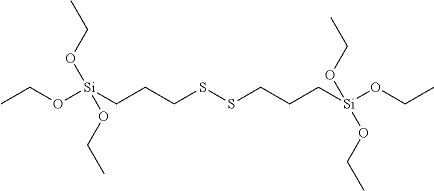 [SMILES: CCO[Si](CCCSSCCC[Si](OCC)(OCC)OCC)(OCC)OCC] | 20.1 |
| 18.97 | 506 | 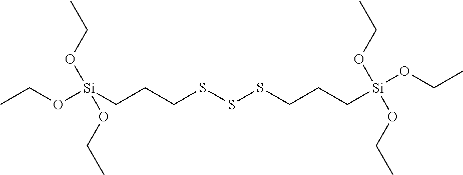 [SMILES: CCO[Si](CCCSSSCCC[Si](OCC)(OCC)OCC)(OCC)OCC] | 33.4 |
| 19.63 | 538 | 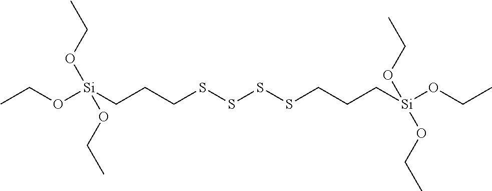 [SMILES: CCO[Si](CCCSSSSCCC[Si](OCC)(OCC)OCC)(OCC)OCC] | 27.3 |
| 20.31 | 570 | 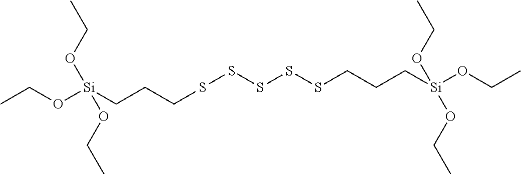 [SMILES: CCO[Si](CCCSSSSSCCC[Si](OCC)(OCC)OCC)(OCC)OCC] | 14.7 |
| 20.94 | 602 | 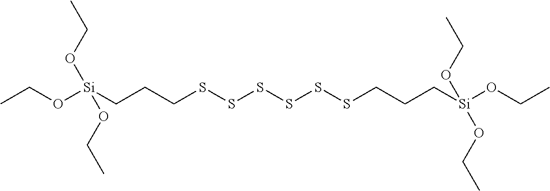 [SMILES: CCO[Si](CCCSSSSSSCCC[Si](OCC)(OCC)OCC)(OCC)OCC] | 4.5 |

To a pre-dried 200 mL round bottle flask purged with dry N₂ gas were added bis(triethoxysilylpropyl) tetrasulfide stock solution (0.508 g, 0.943 mmol) and bis(trimethylsiloxy)methylsilane (0.626 g, 2.81 mmol) together with dry toluene (0.339 g, 3.67 mmol) as solvent. Freshly prepared B(C₆F₅)₃ stock solution was added (0.114 mL, 0.022 mmol) after 5 min stirring. The total reaction time is 3 h, then the reaction was quenched by adding neutral alumina. The product was collected under reduced pressure. The reaction was conducted under identical reaction conditions only changing the ratio of hydrosilane against disulfide [SiH]/[SS] (Table 5).

TABLE 5
Reactivity comparison using bis[3-(triethoxysilyl)propyl]tetrasulfide
and bis(trimethylsiloxy)methylsilane

| | | | | B(C₆F₅)₃ |
|---|---|---|---|---|
| Ratio [SiH]/[SS] | disulfide (g) | BisH (g) | Toluene (g) | (mL)^{a} |
| 1 | 0.50 | 0.21 | 0.22 | 0.038 |
| 2 | 0.50 | 0.41 | 0.27 | 0.076 |
| 3 | 0.50 | 0.63 | 0.34 | 0.114 |
| 4 | 0.50 | 0.83 | 0.40 | 0.152 |
| 5 | 0.50 | 1.08 | 0.47 | 0.190 |
| 6 | 0.50 | 1.28 | 0.58 | 0.228 |
| 7 | 0.50 | 1.48 | 0.60 | 0.266 |
| 8 | 0.50 | 1.67 | 0.66 | 0.304 |
| 9 | 0.50 | 1.88 | 0.72 | 0.342 |
| 10 | 0.50 | 2.07 | 0.78 | 0.380 |
| 11 | 0.50 | 2.27 | 0.85 | 0.418 |
| 12 | 0.50 | 2.48 | 0.90 | 0.456 |

^{a}100 mg mL⁻¹ B(C₆F₅)₃ stock solution

Results

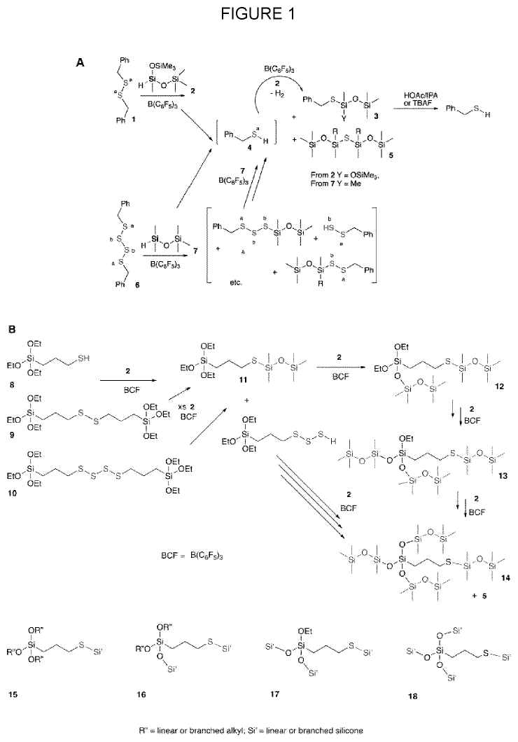

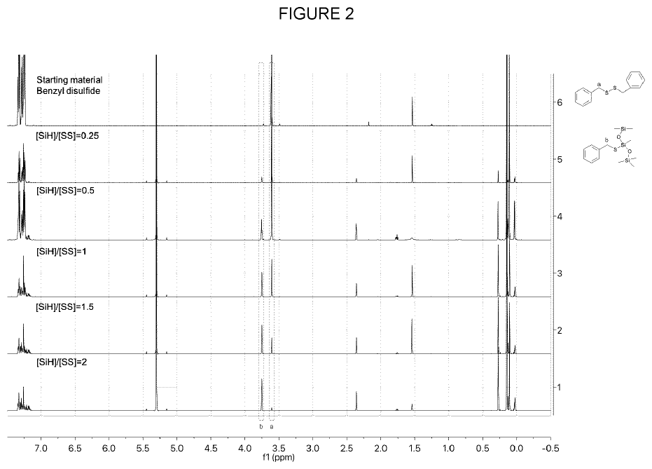

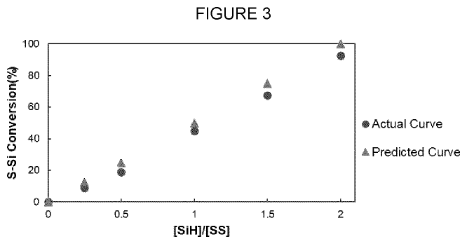

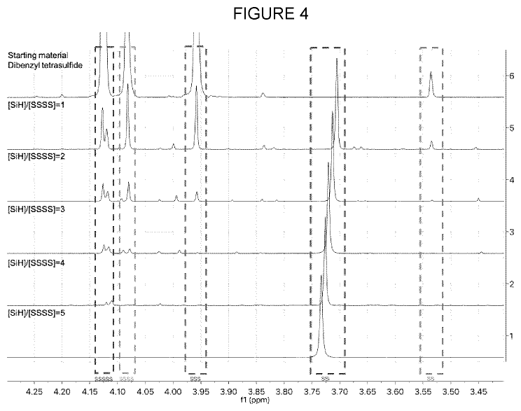

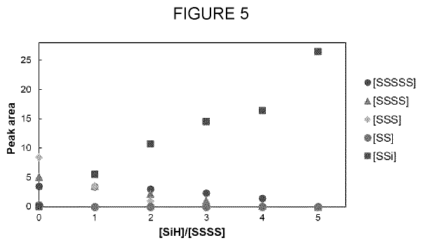

Model compounds demonstrated the efficiency of the reduction reaction. The B(C₆F₅)₃-catalyzed (BCF) reductions of dibenzyl disulfide 1 (n=1) with a small hydrosiloxane HSiMe(OSiMe₃)₂ (BisH) 2 provided a sense of the relative reactivity of the various sulfur bonds (FIG. 1). With less than one equivalent of hydrosiloxane, residual starting material and only product 3 were recovered in the reduction of 1. The thiol (BnSH, PhCH₂SH) 4 was not observed (by ¹H NMR; FIG. 2); complete reduction of 1→3 was obtained with 2 equiv. of the hydrosiloxane and occurred in 90% yield using only 0.8 mol % BCF; the other sulfur-based product 5 was removed under reduced pressure (FIG. 3). The dibenzyl ‘tetrasulfide’ 6 was actually a mixture of PhCH₂SₙCH₂Ph, n=2-6 (n˜3.5). The peak area of the hydrogens on the carbon adjacent to polysulfide bonds including pentasulfide (—CH₂SSSSS), tetrasulfide (—CH₂SSSS), trisulfide (—CH₂SSS) and disulfide (—CH₂SS) in ¹H NMR (FIG. 4) were plotted against different ratio of hydrosilane input. Complete reduction of 6 to give 3 using pentamethyldisiloxane 7 was obtained with five equivalents of BisH (FIG. 5).

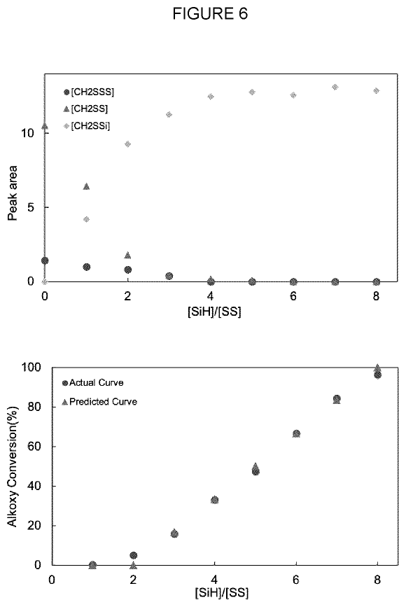

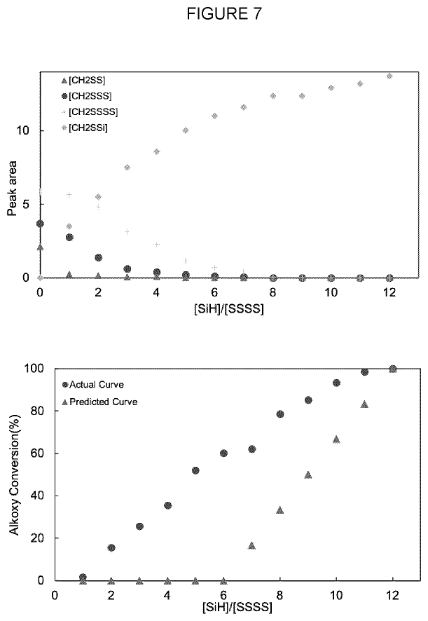

Analogous outcomes were observed when the reductions were repeated with analogous commercial coupling agents that are used to modify silica in ‘green tires’ including, without limitation, alpha-functional coupling agents and gamma-functional coupling agents, such as 8, 9 and 10 (FIG. 1).²² Titrating coupling agents like 9 with 2 showed that the SH group also reacted more rapidly than Si-OEt groups; conversion involved formation first of the silyl thiol ether 11 and via uncharacterized intermediates 12 and 13 leading eventually to the siloxane 14 (analogous products, such as 15, 16, 17, 18 would result from starting materials bearing alternative alkoxy groups OR″, where R″ =alkyl or branched alkyl groups; and products where the siloxanes Si′ are linear or branched silicones). ¹H NMR monitoring were plotted against different ratios of hydrosilane (SiH) input (FIGS. 6 and 7). The predicted curve in FIGS. 6 and 7 was plotted based on the assumption of the reactivities of disulfide and thiol with hydrosilane are faster than that of alkoxysilane.

¹H NMR data following the addition of aliquots of 2 to 10 demonstrated that S_{β}-S_{β} bonds distal to carbon were somewhat more reactive than C—S_{α}-S_{β} bonds, and that S—S bonds were preferentially cleaved over the Si-OEt groups (thus, relative reaction rates are S—H>S—S>Si—OR), but complex mixtures resulted until excess reducing agent was added, at which point the identical product 14 was formed from all three starting materials 8-10 (FIG. 1).

The use of substoichiometric quantities of silicone reducing agents permits the synthesis of monomers useful for the synthesis of sulfur-containing silicones 11-14 and analogous compounds with different alkoxy groups and alternate linear and branched silicone groups are similarly available, for e.g. 15-18 (FIG. 1).

### Example 2. Reduction of Vulcanized Rubbers

Experimental Procedure

Silane materials: Tetramethyldisiloxane (TetraH) was purchased from Gelest and used after drying over molecular sieves overnight.

Rubber samples: Bicycle inner tube (Chaoyang 700×38/45C bicycle inner tube, China), Truck tread 1: a piece of truck tread, not part of a complete tire, was found at a local garbage dump (origin unknown), Truck tread 2: (Sailun 225/70R19.5), EPDM (pond liner, purchased at a local garden center, producer unknown), Crumb-1 (Canadian Eco Rubber Ltd., Emterra, Canada), Crumb-2 (AI's-RC, Amazon, Canada) were used as received. From both truck treads, samples were cut only from the external, road contacting tread part. The tread and side wall samples—cross sections—were cut from different parts of a used car tire (snow tire, Cooper 185/65R4).

Methods: The polymer constituents of rubber samples were estimated from carbon high-resolution magic angle spinning (¹³C HR-MAS) NMR spectroscopy. The oils produced by the silylating reductions were characterized primarily by NMR and TGA as described in Example 1. Molecular weight of recovered organic oil and polydispersity index (PDI) were estimated from gel permeation chromatography (GPC) using a Waters 2695 Separations Module equipped with a Waters 2996 photodiode array detector, a Waters 2414 refractive-index detector, and two Jordi Labs Jordi Gel DVB columns. Polystyrene standards were used for calibration, and THF was used as the eluent at a flow rate of 1.0 mL min⁻¹. The Young's moduli of rubber samples were determined using a MACH-1 micromechanical system (Biomomentum Instruments) with a 0.500 mm hemispherical indenter radius, and Poisson ratio of 0.3. All measurements were conducted at 22° C. and in triplicate, with error bars representing the standard deviation of the replicate measurements.

To prepare powdered rubber, raw rubber samples of different shapes and sizes as well as rubber crumb samples of broad dispersity, with average particles sizes of 2.14±0.06 mm for Crumb-1 and 1.30±0.09 mm for Crumb-2, were obtained. A cryogenic grinding progress was used to obtain rubber powder samples with homogeneous particle sizes for comparable experiment. Liquid nitrogen was employed to cool the rubber samples below their glass transition temperature before they were pulverized with a coffee grinder (KitchenAid) to give powders with an average particle size of ˜330 μm. Bulk samples were cut directly from different parts of a car tire using a reciprocating saw.

As raw rubber samples may contain organic additives, including oil or other additives that could influence the reductive cleavage process, in a control experiment, the extractable components were extracted prior to reduction. The most commonly used extraction solvent²³ acetone, was used to remove resins, free sulfur, acetone soluble softeners and antioxidants, processing rubber additives, mineral oils, waxes, organic accelerators and their reactive products and fatty acids. The Soxhlet extraction procedure was as follows: 5.0 g raw truck tread 1 rubber powder was placed inside Whatman cellulose extraction thimble (33 mm×118 mm). The sample containing the thimble was extracted with 200 ml refluxing acetone 56° C. for 72 h in a standard Soxhlet apparatus. After this purification, the sample was dried in 100° C. oven overnight. The weight of collected sample was 4.48 g.

The general experimental procedure (with powders or coupons) is as follows: The cryogenically ground rubber powder was allowed to swell in dry toluene (12 mL) for 30 min. Pentamethyldisiloxane 7 was added to the reaction mixture. Then the stock catalyst solution was added to initiate the reaction. The suspension was heated in a 60° C. oil bath for 48 h. The residual undissolved rubber powder was washed with toluene and separated by centrifugation (Eppendorf, Centrifuge 5424, at 12000 rpm for 20 min). The extraction process was repeated two times to completely remove soluble compounds. The supernatants were mixed, and the solvent was removed by rotary evaporation. Any residual (organic) volatiles were removed under a stream of N₂ over 24 h. The residual rubber powders were dried at 100° C. overnight and then examined by TGA. The reaction conditions for the reduction of rubber powder are as follows: 300 mg powdered sample; pentamethyldisiloxane 7 1.5 mL (1.14 g, 7.7 mmol), BCF/Rubber=10 wt %, 12 mL toluene, 60° C., 48 h. The recovered organic liquid was characterized by NMR.

The organic yields were calculated from TGA profiles:

$$Organic Yield \% = \frac{{m}_{0} \times {W}_{0} - {m}_{i} \times {W}_{i}}{{m}_{0} \times {W}_{0}} \times 100$$

Where m₀ is the mass of starting rubber and mi is the mass of residual solid. W₀ is the organic weight % in starting rubber. Wᵢ is the organic weight % in residual solid. Both W₀ and W₁ is from TGA.

The experimental procedure for the reduction of bulk samples is as follows: The raw tread bulk (cross-section, 2.083 g, ˜1.200 cm×1.519 cm×1.125 cm, containing metal and fiber) was allowed to swell in dry toluene (80 mL) for 6 h. Pentamethyldisiloxane (7.6 g, 51.35 mmol, 10 mL) was added to the reaction mixture. Several ceramic beads were added to increase shear force while stirring with a magnetic stirrer. BCF catalyst was added portion by portion each 24 h (6+2+2+2 wt % B(C₆F₅)₃). The reaction mixture was heated in a 60° C. oil bath for 6 d. The residual undissolved rubber bulk was washed with toluene and dried in a 100° C. oven. The suspension was centrifuged, then washed, and re-centrifuged (repeated twice). The supernatants were mixed, and the solvent was removed by rotary evaporation. The volatile organics were removed by blowing with a stream of N₂ for 48 h. The residual (now smaller) rubber bulk (0.460 g, broken in two pieces: 0.675 cm×1.331 cm×0.445 cm, 0.754 cm×0.937 cm×0.340 cm) and powder (0.527 g) were separately examined using TGA. The recovered organic liquid was characterized by NMR.

Multiple reductions of bulk rubber: The residual solid after the first reduction (300 mg) was ground cryogenically (under liq. N₂) and subjected to a secondary reduction using fresh catalyst (30 mg) and pentamethyldisiloxane (1.14 g, 1.5 ml). The reduction was carried out for 48 h in a 60° C. oil bath, followed with an additional wash sequence. A similar protocol was followed using a piece of sidewall (1.595×1.427×0.6096 cm, 1.475 g; which led to 1.427×1.409×0.549 cm). Experimental conditions for the first reduction: BCF/Rubber=12 wt % (added portion by portion: 6+2+2+2), 6 days, 60° C. The residual bulk materials from the first reduction were ground into a powder prior to the second reduction. Experimental conditions for the second reduction: BCF/Rubber=10 wt % (added all at once), 48 h, 60° C. Only metal was removed from the elastomer matrix in first reduction step; polymeric fiber remained bound to the residual bulk solid.

Reduction with tetramethyldisiloxane: Cryogenically ground inner tube powder (300 mg) was placed in dry toluene (12 mL), followed by tetramethyldisiloxane (1.5 mL, 8.5 mmol). The stock catalyst solution (600 μL, stock catalyst concentration: 50 mg/mL in toluene, catalyst concentration in reaction: 10 wt %/inner tube) was added immediately afterwards to initiate the reaction. The suspension was heated in a preheated 100° C. oil bath for 30 min. The reaction flask was put into a room temperature water bath to quench the reaction and followed by a separation process using the same protocol as described above. The organic yield was 87%.

Results

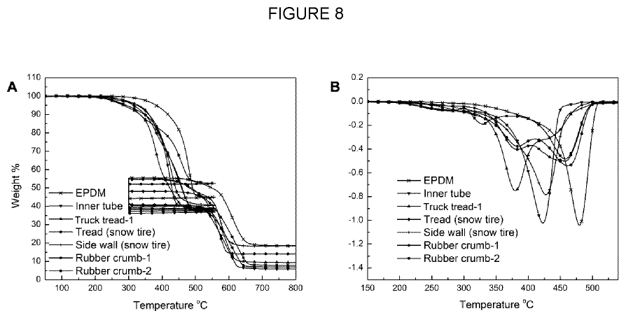

Inner tubes (bicycle) and side walls (automobile) frequently contain high quantities of polyisobutylene (PIB), while tread rubber often contains higher fractions of PIB, polybutadiene (PDB), polyisoprene (PIP) and natural rubber (NR). The constitution of the elastomeric component of the rubber materials was determined by NMR and, particularly, by their thermogravimetric degradation profile between 50-560° C. (Table 6) butyl rubber (inner tubes) decomposes from 387-430° C., Tₘₐₓ at 412° C.²⁴ polyisoprene from 300-450° C., Tₘₐₓ at 365° C.; polybutadiene from 350-485° C., Tₘₐₓ at 465° C. and styrene-butadiene rubber from 325-465° C., Tₘₐₓ at 447° C.;²⁵ inorganic carbon (carbon black) thermally decomposes from 560-800° C. in oxygen.²⁶ TGA and differential thermal analysis (DTA) data show the constituents of the rubber samples tested (FIG. 8).

TABLE 6
Rubber components characterized by TGA profile

| Component | % Mass Loss |
|---|---|
| Organic materials | 50° C. to 550° C. (nitrogen) |
| Carbon black | 560° C. to 800° C. (air) |
| Ash | Residue at 800° C. |

Elastomers including EPDM (ethylene propylene diene monomer terpolymer, ‘pond liner’), PIB (bicycle inner tube), truck tread, automobile side wall, automobile tread, and commercially available ‘rubber crumb’ (scrap rubber from automobile tires formed by shredding tires from multiple sources to remove metal wires and polyester cord and grinding the resulting product to various crumb sizes) were exposed to reductive silylation conditions. In the samples tested, the organic rubber content was approximately 60 wt % (Table 7).

TABLE 7
Constituents in rubber starting materials

| | | Components | | |
|---|---|---|---|---|
| | Rubber | Organic | Carbon black | Other solids |
| Rubber | constituents^{a} | % | % | % |
| EPDM | EPDM | 55.1 | 26.4 | 18.5 |
| Inner Tube | | 61.1 | 33.0 | 5.9 |
| Truck Tread-1 | PIP/NR | 62.2 | 28.4 | 9.4 |
| Truck Tread-2 | PIP/NR + PBD | 65.0 | 23.0 | 12.0 |
| Tread (Snow tire) | PIP/NR + PBD | 63.0 | 22.9 | 14.1 |
| Side Wall | PIB + PIP/ | 59.4 | 22.2 | 18.4 |
| (Snow tire) | NR + PBD | | | |
| Crumb-1 | EPDM + PBD | 61.6 | 31.5 | 6.9 |
| Crumb-2 | PIB + PBD | 47.6 | 44.6 | 8.8 |

^{a}EPDM terpolymer of ethylene, propylene and diene, PIP/NR polyisoprene/natural rubber, PIB polyisobutylene, PBD polybutadiene. Constituents were determined by a combination of TGA, which showed separate decomposition temperatures for PIB and PIP, and ¹H NMR.

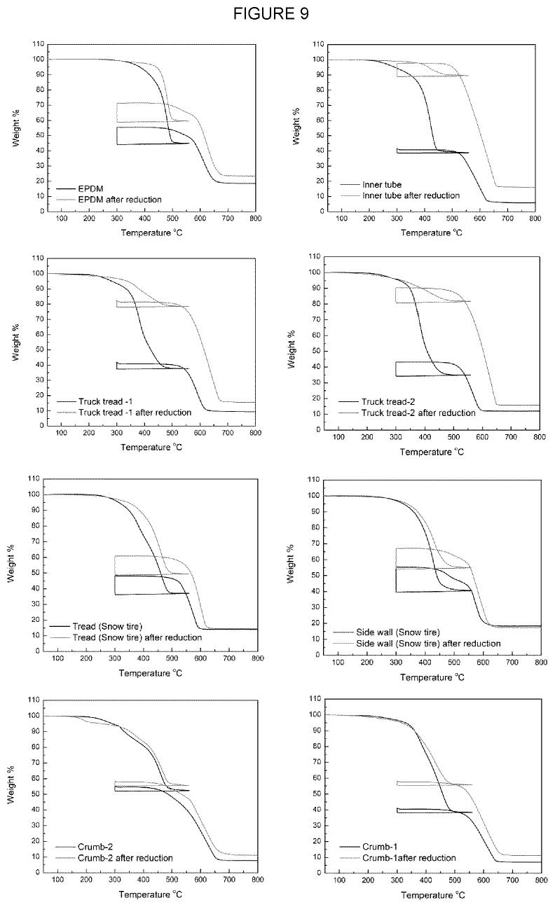

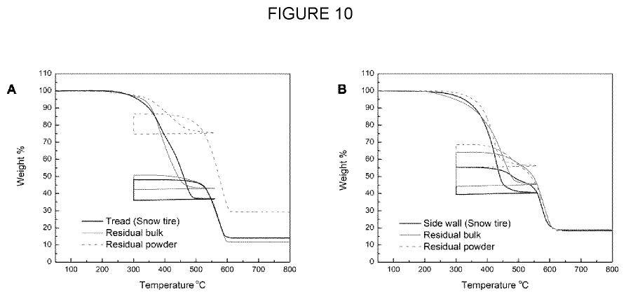

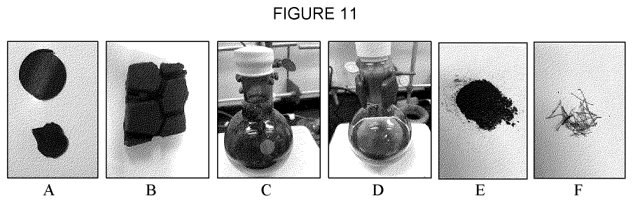

With PentaH as reducing agent, the yields for reduction—as judged by the fraction of organic oils that could be separated by filtration from inorganic constituents, including carbon black and other excipients (e.g. metal wires can be magnetically separated from the bulk rubber after reduction)—ranged from about 36% up to 93% (Table 8). Two separate sources of commercial crumb were compared for their reactivity under the reducing silylation conditions. The reduction process was readily visible by eye, as black dispersions were converted to yellow oils. Much more BCF catalyst (10 wt % compared to the rubber starting material) was required to achieve reasonable yields of reduction with rubbers than with the model compounds (<1 mol %), which is not surprising given the complexity of the mixed rubber starting materials and the fact that they have been exposed to degradation and various environments during use. The efficiency of the reduction of rubber samples was dependent on catalyst concentration. With 1 wt % BCF catalyst concentration, (60 μL of catalyst containing 3 mg of B(C₆F₅)₃ for 300 mg of inner tube powder in 12 mL of toluene with 113 μL of PentaH, 60° C., 48 h), 41% (organic yield calculated by TGA data) of the organic compound in rubber could be reduced to soluble polymers, while at higher catalyst concentrations (B(C₆F₅)₃/Rubber=10 wt %), the organic yield reaches 93%. The TGA data before and after reduction for the different rubbers is found in FIG. 9, showing that the residual material was mostly carbon black (76%) and thermally stable inorganic entities (13%). Improved recoveries of organic polymers were observed with single composition rubbers. For example, about 60% of an EPDM elastomer (ethylene propylene diene terpolymer, ‘pond liner’) was converted to a soluble oil using reductive silylation with PentaH and BCF in toluene at 60° C. Irrespective of origin, the efficiency of reductive silylation of sulfides, as measured by the recovery of organic oils, increased with surface area of the rubber (FIG. 10), i.e. powdered rubber underwent more rapid reduction than bulk rubber samples: the reaction efficiency for inner tube coupons at 60° C. for 48 hours was 62% (FIG. 11), whereas a 93% yield for inner tube powder was achieved under the same conditions (and also at 100° C. after 18 hours).

TABLE 8
Depolymerization efficiency of organic elastomers by hydrosilanes

| | | Starting rubber | | | |
|---|---|---|---|---|---|
| | | components^{b} | | Results | |
| | | Organic | Inorganic^{c} | Organic | Residual |
| | | fraction | fraction | yield^{d} | solid^{e} |
| Rubber^{a} | | (mg) | (mg) | (%) | (mg) |
| EPDM - powder | | 165 | 135 | 60.4 | 162.0 |
| Inner Tube - coupon | | 183 | 117 | 62.4 | 49.0 + 118.0^{f} |
| Inner Tube - powder | | 183 | 117 | 92.9 | 112.7 |
| Inner Tube - powder^{g} | | 1222 | 778 | 89.1 | 821.0 |
| Inner Tube - powder^{h} | | 183 | 117 | 79.0 | 150.0 |
| Inner Tube - powder^{h} | | 183 | 117 | 80.3 | 143.3 |
| Inner Tube - powder^{h} | | 183 | 117 | 81.5 | 142.3 |
| Inner Tube - powder^{h} | | 183 | 117 | 85.0 | 122.0 |
| Inner Tube - powder^{h} | | 183 | 117 | 87.0 | 151.0 |
| Inner Tube - powderⁱ | | 183 | 117 | 85.0 | 151.0 |
| Truck Tread 1 - powder | | 187 | 113 | 88.3 | 109.5 |
| Truck Tread 1 - Soxhlet | | 175 | 125 | 87.6 | 115.1 |
| extracted powder | | | | | |
| Truck Tread 1 - powder^{g} | | 1244 | 756 | 84.6 | 861.0 |
| Truck Tread 2 - powder | | | | | |
| Tread (snow tire) - powder | | 189 | 111 | 51.8 | 180.0 |
| Side wall (snow tire) - | | 178 | 122 | 53.8 | 183.0 |
| powder | | | | | |
| Crumb-2 - powder | | 143 | 157 | 35.8 | 206.7 |
| Crumb-1 - | First^{j} | 185 | 115 | 56.2 | 182.9 |
| powder | Second^{j} | 80.9 | 102 | 85.8 | 74.0 |
| | Third^{j} | 26.3 | 47.7 | 88.3 | 64.0 |

^{a}Experimental conditions: 300 mg powdered sample; PentaH 1.5 mL (1.14 g, 7.7 mmol), BCF/Rubber = 10 wt %, 12 mL toluene.
^{b}Based on TGA.
^{c}Includes carbon black and thermally stable inorganic moieties.
^{d}Fraction of available elastomer converted into organic soluble oils.
^{e}Residual solid contains carbon black, inorganics and residual polymeric rubber.
^{f}49.0 mg of residual powder and 188 mg of residual coupon still containing elastomer.
^{g}2000 mg of starting elastomer was used, PentaH 10.0 mL, B(C₆F₅)₃/Rubber = 10 wt %, 80 mL toluene, 60° C., 48 h.
^{h}The rubber powder was allowed to swell in reaction mixture for 3 h before adding B(C₆F₅)₃ catalyst.
ⁱCatalyst solution was added immediately after addition of hydrosilane.
^{j}Process for degradation of Crumb-1 using multiple reduction cycles; 169.0 mg of starting material were used in the 2^{nd} reduction and 65.0 mg in the 3^{rd} (FIG. 8).

Since elevated, but still mild, temperatures were more effective than room temperature, in this work, 60° C. was selected as a convenient reaction temperature to avoid the possibility of BCF degradation beyond 80° C. in the presence of moisture.²⁷ These studies with rubber reduction, however, showed this not to be problematic. A 93% yield of recovered organic polymer (PIB from inner tube) was achieved at 100° C. after 18 hours, but an 87% yield had already been achieved in the first 30 minutes (Table 9). This result suggests that reduction processes at 100° C. or higher, for example up to 130° C., could be adapted to a continuous process.

TABLE 9
Parameters for depolymerization of organic
elastomers by hydrosilanes

| | | | | Results |
|---|---|---|---|---|
| | | Parameters | | Organic |
| | | Hydro-silane | Temp (° C.) | yield^{d} |
| Rubber^{a,b} | | (mL) | & Time (h) | (%) |
| EPDM - powder | | PentaH (1.5) | 60/48 | 60.4 |
| Inner Tube - coupon | | PentaH (1.5) | 60/48 | 62.4 |
| Inner Tube - powder | | PentaH (1.5) | 60/48 | 92.9 |
| Inner Tube - powder^{g} | | PentaH (10) | 60/48 | 89.1 |
| Inner Tube - powder^{h} | | PentaH (1.5) | 100/0.5 | 79.0 |
| Inner Tube - powder^{h} | | PentaH (1.5) | 100/2 | 80.3 |
| Inner Tube - powder^{h} | | PentaH (1.5) | 100/4 | 81.5 |
| Inner Tube - powder^{h} | | PentaH (1.5) | 100/10 | 85.0 |
| Inner Tube - powder^{h} | | TetraH (1.5) | 100/0.5 | 87.0 |
| Inner Tube - powderⁱ | | TetraH (1.5) | 100/0.5 | 85.0 |
| Truck Tread 1 - powder | | PentaH (1.5) | 60/48 | 88.3 |
| Truck Tread 1 - Soxhlet | | PentaH (1.5) | 60/48 | 87.6 |
| extracted powder | | | | |
| Truck Tread 1 - powder^{g} | | PentaH (10) | 60/48 | 84.6 |
| Truck Tread 2 - powder | | | | |
| Tread (snow tire) - powder | | PentaH (1.5) | 60/48 | 51.8 |
| Side wall (snow tire) - | | PentaH (1.5) | 60/48 | 53.8 |
| powder | | | | |
| Crumb-2 - powder | | PentaH (1.5) | 60/48 | 35.8 |
| Crumb-1 - | First^{j} | PentaH (1.5) | 60/48 | 56.2 |
| powder | Second^{j} | PentaH (1.5) | 60/48 | 85.8 |
| | Third^{j} | PentaH (1.5) | 60/48 | 88.3 |

^{a}Experimental conditions: 300 mg powdered sample; PentaH 1.5 mL (1.14 g, 7.7 mmol), BCF/Rubber = 10 wt %, 12 mL toluene.
^{b}Based on TGA.
^{c}Includes carbon black and thermally stable inorganic moieties.
^{d}Fraction of available elastomer converted into organic soluble oils.
^{e}Residual solid contains carbon black, inorganics and residual polymeric rubber.
^{f}49.0 mg of residual powder and 188 mg of residual coupon still containing elastomer.
^{g}2000 mg of starting elastomer was used, PentaH 10.0 mL, B(C₆F₅)₃/Rubber = 10 wt %, 80 mL toluene, 60° C., 48 h.
^{h}The rubber powder was allowed to swell in reaction mixture for 3 h before adding B(C₆F₅)₃ catalyst.
ⁱCatalyst solution was added immediately after addition of hydrosilane.
^{j}Process for degradation of Crumb-1 using multiple reduction cycles; 169.0 mg of starting material were used in the 2^{nd} reduction and 65.0 mg in the 3^{rd} (FIG. 8).

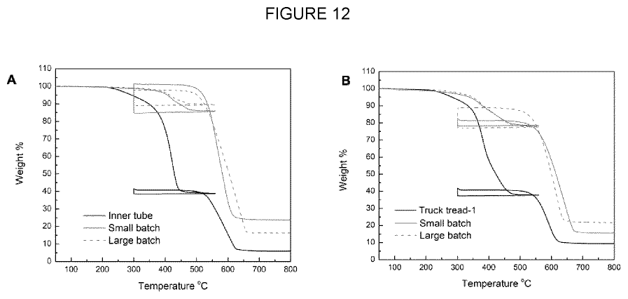

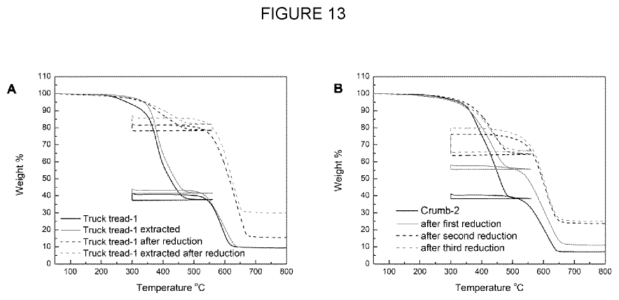

Increasing the scale from 300 to 2000 mg did not significantly change the efficiency of the process (FIG. 12). The effect of Soxhlet extraction was minor: without limitation, pre-swelling the rubber in commonly used organic solvents like acetone,²³ or an initial Soxhlet extraction using acetone to remove potential catalyst inhibitors, e.g., amines, free sulfur, acetone soluble colorants, antioxidants, processing rubber additives, etc., did not appreciably increase either the rate or yield of the reduction (FIG. 13A).

Loss of organic polymer led to elastomer shrinkage after a first reduction, leading to a more highly crosslinked residual structure, as shown by an increase in Young's modulus (Table 10), but maintained their shape. Attempts were made to undertake second and third reduction steps using fresh catalyst and hydrosilane in the hopes of improving overall conversion of elastomer to linear oils (FIG. 13B). Sequential reactions showed that it was possible to capture additional depolymerized material in a second step, but it was not particularly efficient in bulk form: recovery in each sequential reduction 56→29.6→2.5% (total 88%)—the inorganic constituents were removed by centrifugal separation. In a practical sense, only the improvement in overall efficiency of the second step could be justified. The inability to completely recover the organic polymer irrespective of its constitution suggests that some crosslinks are not susceptible to reduction, which may include links due to simple sulfides (which were not reactive under these reducing conditions), those arising from peroxide cure, etc.

TABLE 10
Decrosslinking of bulk rubber; effect of multiple repetitions

| | | | | | | | | | Young's |
|---|---|---|---|---|---|---|---|---|---|
| | | | | Constitution of Residue | | | | Recovered | modulus of |
| | Starting | Starting | | | | | Total | volatile | bulk |
| Rubber | material | mass | PentaH | Bulk | Powder | Metal^{d} | mass | liquid | Before/After |
| type | Characteristics | (mg) | (mL) | (mg) | (mg) | (mg) | (mg) | (mg) | (MPa) |
| Side Wall | First (Bulk | 1475 | 7.4 | 1197 | 48 | 0 | 1245 | 142 | 5.52 ± 1.21/ |
| | with fiber)^{a} | | | | | | | | 16.86 ± 1.36 |
| Side Wall^{b} | Second | 300 | 1.5 | — | 204 | — | 204 | 221 | — |
| | (Powder, no | | | | | | | | |
| | metal or fiber)^{c} | | | | | | | | |
| Tread | First (Bulk | 2083 | 10.0 | 460 | 527 | 294 | 1281 | 830 | 22.28 ± 1.62/ |
| | with metal | | | | | | | | 57.78 ± 2.40 |
| | and fiber)^{a} | | | | | | | | |
| Tread^{b} | Second | 300 | 1.5 | — | 214 | — | 214 | 183 | — |
| | (Powder, no | | | | | | | | |
| | metal or fiber)^{c} | | | | | | | | |

^{a}Experimental conditions for the first reduction: BCF/ Rubber = 12 wt % (added portion by portion: 6 + 2 + 2 + 2), 6 days, 60° C.
^{b}The residual bulk materials from the first reduction were ground into a powder prior to the second reduction.
^{c}Experimental conditions for the second reduction: BCF/Rubber = 10 wt % (added all at once), 48 h, 60° C.
^{d}Note: Only metal was removed from the elastomer matrix in step 1; polymeric fiber; remained bound to the residual bulk solid.

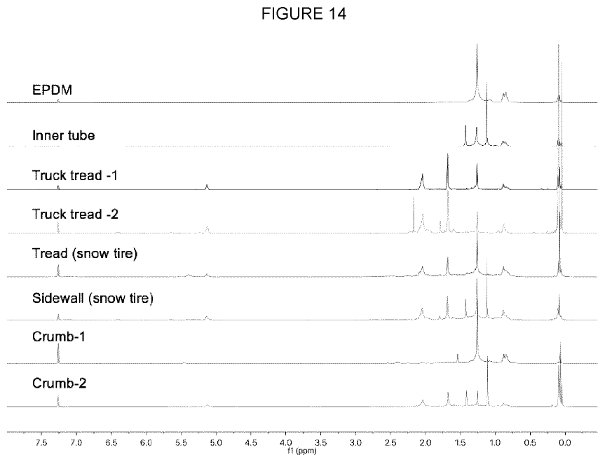

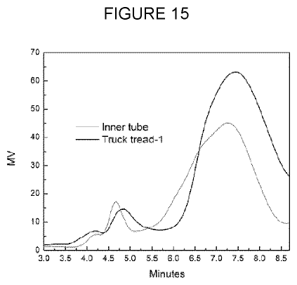

Oligosulfides were converted into silyl thiol ethers during reduction. Therefore, the residual solids and recovered non-volatile liquids often exhibited a weight gain when compared to the starting rubber mass. The constituent rubber components, as shown by ¹H NMR, are consistent with the TGA data on the starting elastomers (FIG. 14). The germinal dimethyl groups on the backbone of polyisobutylene is particularly characteristic, as are backbone methyl groups from propylene and isoprene units. The product oils typically exhibited a bimodal distribution of molecular weight, with a low faction centered near the 10,000 g mol⁻¹ range and a broad peak centered near 1 million g mol⁻¹ (FIG. 15).

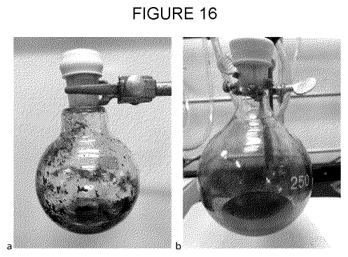

Several factors were manipulated to improve the efficiency of the reduction process. A variety of hydrosilicones are commercially available that vary in the density of SiH groups. Model studies on the reduction of the organic sulfides or automotive rubbers were undertaken with 2 or 7, respectively, because the use of small molecules facilitated characterization of the reaction products. However, either compound is too expensive for practical use. Attempts to facilitate reduction of rubbers with the inexpensive, high SiH density polymer Me₃Si(OSiMeH)ₙSiMe₃ 19 were unsuccessful because the silicone product of the reduction is a network polymer, which led to the formation of intractable tars. By contrast, the use of inexpensive, high SiH density HMe₂SiOSiMe₂H 20 (TetraH) led to efficacious, rapid reduction of rubbers (Table 9, FIG. 16).

### Example 3. Desilylation and Reoxidation

Experimental Procedure

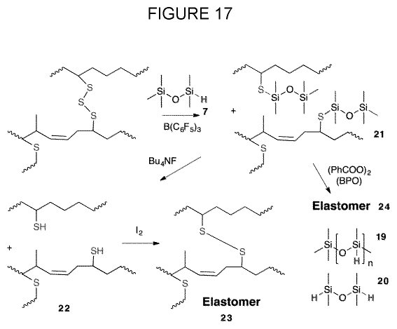

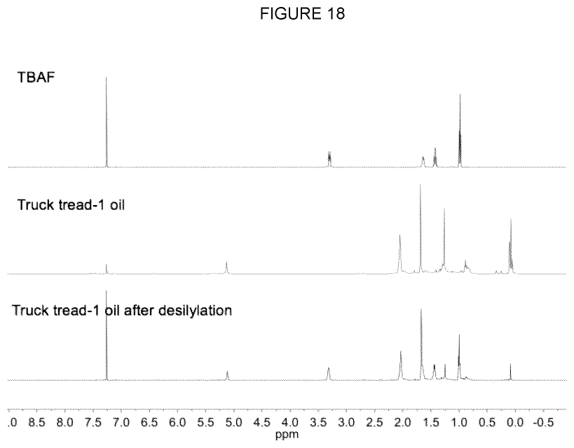

Tetrabutylammonium fluoride trihydrate (TBAF; Bu₄NF) and iodine (I₂) were obtained from Sigma Aldrich and used as received. The silylated organic oil 21 in FIG. 17 (tire tread, 0.50 g) was desilylated by treatment with TBAF solution (0.5 g TBAF, 1.92 mmol TBAF, dissolved in 10 ml THE containing 0.1 ml methanol) for 24 h at 80° C. The solvent and siloxane fragments were removed by using a rotary evaporator, followed by kugelrohr distillation; loss of silicone was clearly seen in the ¹H NMR (200° C., 3 h; FIG. 18).

The desilylated organic oil 2 (FIG. 17, derived from truck tread 0.2 g) was allowed to react with an iodine solution (50 mM dissolved in 1/1 v/v toluene/isopropanol) for 12 h at room temperature. Solvents associated with the resulting elastomer 3 were removed under a stream of N₂ over 12 h. Crosslinking was confirmed using a swelling test. Compound 3 (0.1 g) was swelled in 10 ml of hexane; the degree of swelling was 209 wt %.

Results

Initial studies for reusing/re-crosslinking the recovered oil focused initially on the regeneration of thiols from silyl thio ethers. Me₃Si—S—SiMe₃ is very labile, undergoing rapid degradation simply in the presence of water (vapor) to form H₂S and Me₃SiOH. By contrast, the hydrolysis of silicone-based thio ethers was much less facile. Alcoholysis of 2 yielded 12% product only once acetic acid was added to isopropanol solutions (the less sterically hindered thio ether PhCH₂SSiMe₂OSiMe₃ underwent rapid, quantitative cleavage under the same conditions). The silylated polymeric oils derived from elastomers 21 were yet less reactive. It was necessary to use more aggressive nucleophiles for silicon, such as TBAF to regenerate the silyl free thiols 22 (FIG. 17). The samples gained weight as a pure organic matrix was converted a silicone/organic matrix.

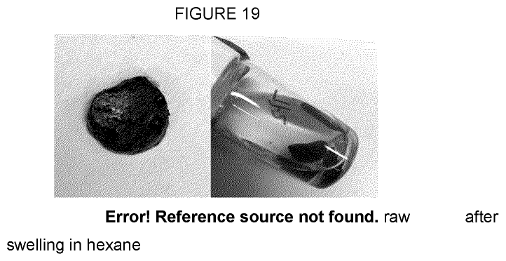

Once cleaved, the free thiols on the organic polymers remained susceptible to oxidative coupling. Addition of iodine in isopropyl alcohol to a solution of the oil recovered from truck tread (origin unknown) led to a new elastomer 3 (FIG. 17). The precursor oil dissolved readily in hexane easily while 3 remained an elastomeric solid even after 1 h sonication (FIG. 19).

### Example 4. Recrosslinking Recovered Polymeric Oil by Peroxides

Experimental Procedure

A silicone mold was prepared with a two-part liquid component kit (Sylgard 184). Two components were mixed at the recommended ratio of 10 parts (10.0 g) base to 1 part curing agent (1.0 g). The mixing process was performed using a planetary centrifugal mixer (FlackTek Inc.) with a duration of 5 min at a speed of 3000 rpm. In order to fabricate bubble free elastomer, the mixed uncured PDMS was thoroughly degassed in a vacuum desiccator at low pressure for 30 min. The right front tire of a toy car (outer diameter˜2.5 cm) was removed from the toy and placed in the degassed, uncured mixture. The mixture was cured in an 80° C. oven overnight. The tire was removed from the cured mold.

Used rubber powder from the truck tread (Sailun) (2.0 g) was reduced by PentaH in a 100° C. oil bath for 18 h to give a polymeric oil 21 (81.5% yield). The oil was accompanied by residual undissolved rubber powder and excipients that was washed with toluene and separated by centrifugation (Eppendorf, Centrifuge 5424, at 12 000 rpm for 20 min). Solvents in the supernatants, after centrifugation, were removed by rotary evaporation, any residual volatiles and silicone by-products were removed using a stream of N₂ over 24 h. The recovered solids were dried in an 80° C. oven for 18 h, and ground into powder using a mortar and pestle. The silylated organic oil 21 from the former step (comprised of PIP/NR derivatives, 0.707 g) was dissolved in hexanes (10 mL), benzoyl peroxide (BPO, 0.01 g, 1 wt %, 0.0413 mmol) and, optionally, ground residual inorganic solids (from the preparation of 21, 0.3010 g), were added sequentially and mixed to give a homogeneous dispersion. After the solvent was removed by rotary evaporation, the mixture was placed in the silicone mold and degassed under vacuum in a desiccator for 30 min. The curing process was performed at 100° C. for 18 h. The formulations for rubber with different residual solid are listed in Table 11.

TABLE 11
Recrosslinking of recovered organic oil with
residual solid as reinforcing agent

| Organic oil | Ground residual | | |
|---|---|---|---|
| (truck tire, g) | solid (g) | BPO (g) | Hardness |
| 1.000 | 0.000 | 0.010 | 68 ± 3 (Shore OO) |
| 0.700 | 0.300 | 0.010 | 91 ± 4 (Shore A) |

Results

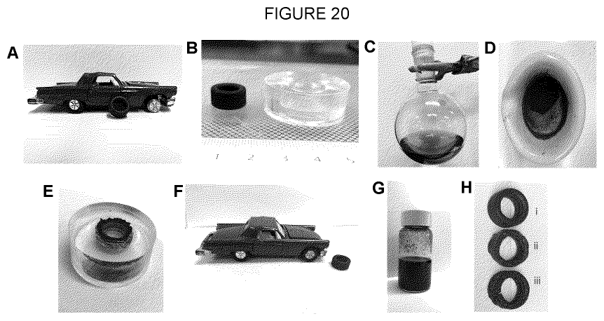

It was found that if silylated polymers were derived from PIP/NR or PBD and possessed residual alkenes, re-crosslinking did not require removal of the silyl groups; simply adding a radical initiator such as benzoyl peroxide (BPO) and heating led to new elastomers 24 (FIG. 17). The ability to create new elastomers from the recovered polymeric oils was demonstrated by creating a new automotive tire for a child's toy using a mold of the tire made in silicone rubber (FIGS. 20A and 20B). Silylated oil 21 derived from PIP/NR (tire tread) was placed in the mold in the presence of BPO and heated to give a new, soft elastomer (durometer Shore 00 68, Table 11). Adding to 21 the inorganic excipients (recovered from the production of 21; FIG. 20H), and then curing oxidatively, led to harder, more brittle elastomers (Shore A 91; original rubber Shore A 60).

### Example 5. Cleaning Rubber Contaminated Steel

Experimental Procedure

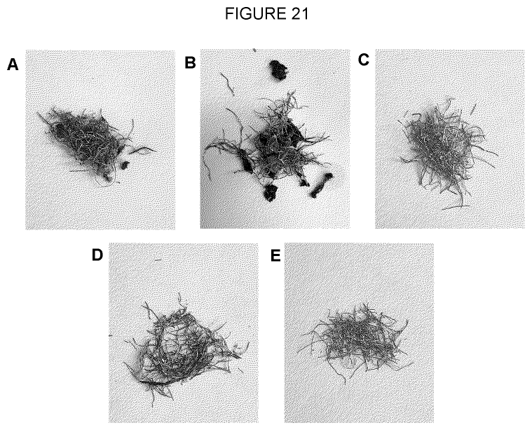

Rubber contaminated steel that is usually considered as waste from tire recycling was received from eTracks (Oakville, Canada). The rubber contaminated steel (1.0 g FIG. 21A), tetramethyldisiloxane (1.5 ml), and toluene (12 ml), (1.5 ml) were added into 50 ml round-bottomed flask. The reaction mixture was stirred using a magnetic stir bar at 500 rpm and a portion of glass beads were added to increase the shear force. After the reaction reached 100° C., 100 μl B(C₆F₅)₃ catalyst stock solution (concentration: 50 mg/ml in toluene, B(C₆F₅)₃/steel=0.5 wt %) were added. The reaction mixture was then left at 100° C. for 18 h. The treated steel was collected by a magnet, followed by physical grinding with a mortar for 1-2 min. The mass of received clean steel recovered was 0.7 g.

Results

It was found that after treating rubber contaminated steel with 0.5 wt % BCF/steel and excess tetramethyldisiloxane, most of the metal was clean. The small amount of residual rubber adhering to the metal surface (FIG. 21B) could be simply removed by mechanical abrasion and magnetic separation (FIG. 21C). Note in FIG. 21D that mechanical force does not clean the rubber contaminated steel, i.e., where neither hydrosilane, nor B(C₆F₅)₃ catalyst was added.

It should be noted that the reaction solution could be used multiple times. Addition of a second portion of contaminated steel (1.0 g) to the solution of the former treatment lead to clean steel (FIG. 21E) led to a comparable cleaning efficiency, showing further potential to reducing the cost and enhance environmental performance.

### Example 6. Control Experiments, Thermal Conversion of Rubber, and in the Presence of Hydrosilanes without Catalysts

The degradation of rubber crumb was performed in a Haake Toque Rheomix mixer with a rotor speed of 60 rpm at 140° C. Prior to reaction, rubber crumb (190 g) was premixed with hydrosilane (e.g., M^{H}D₄M^{H}, HMe₂Si(OSiMe₂)₄OSiMe₂H, 20 ml) or non-functional silicone oil (MD₂₅M, Me₃Si(OSiMe₂)₂₅OSiMe₃) for about 5 min. The premixed crumb was allowed to mix in the Haake chamber for 40 min. The obtained admixture was an oily black solid crumb. After reaction, 1 g of the crumb was soaked in 10 ml toluene for 24 h and the residual solid was centrifuged down. The extraction process was repeated 5 times. The supernatants were combined and the solvents were removed by rotary evaporation. Small amounts of residual volatiles were removed under a stream of N₂ flow until the mass stabilized. The residual solid was dried in vacuum oven for 24 h. The extraction results are summarized in Table 12.

Results

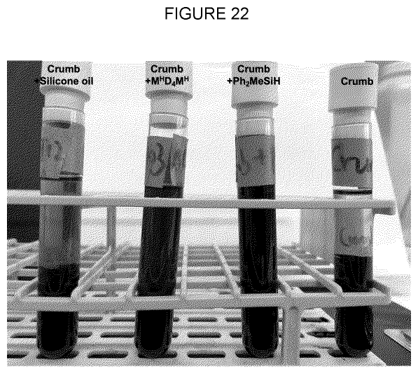

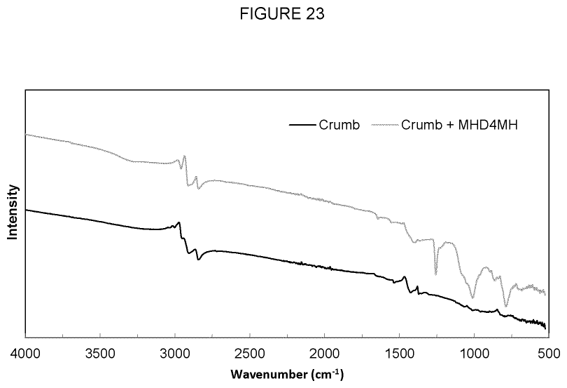

As shown in FIG. 22, samples treated with the hydrosilane formed darkly colored solutions during extraction, which is attributed to partial release of carbon black after partial crumb depolymerization. Additional evidence of thermal reduction using hydrosilanes is provided by FT-IR spectra. Rubber crumb after Si—H treatment (FIG. 23) shows the presence of a typical band for Si—O—Si at 1010 cm⁻¹ and SiCH₃ at 1250 cm⁻¹, which does not exist in untreated or thermally treated rubber crumb. As shown in Table 12, only a small fraction of the rubber underwent decomposition, the fraction was higher in the presence of the hydrosilane. These results show that the efficiency of rubber degradation follows the tread thermal<thermal+hydrosilicone/hydrosilane<<hydrosilicone/hydrosilane plus B(C₆F₅)₃.

TABLE 12
Parameters for depolymerization of organic elastomers by
hydrosilanes using Haake

| | | Extraction Results | | |
|---|---|---|---|---|
| Reaction Parameters | | | Extracted | |
| Rubber | Siloxane | Crumb after | organic | Residual |
| (g) | (mL) | reaction (g) | liquid (g) | solid (g) |
| Crumb -1(190) | — | 1.0^{a} | 0.102 | 0.899 |
| Crumb -1(190) | MD₂₅M (20) | 1.0 | 0.146 | 0.853 |
| Crumb -1(190) | Ph₂SiMeH (20) | 1.0 | 0.192 | 0.803 |
| Crumb -1(190) | M^{H}D₄M^{H} (20) | 1.0 | 0.205 | 0.747 |

^{a}Crumb without being reacted in Haake

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE APPLICATION

1. Goodyear, C., Improvement in India-Rubber Fabrics. US Patent 1844, 3633.
2. World Tires (www.freedoniagroup.com/industry-study/world-tires-3357.htm). Freedonia Group 2015, Industry Study 3357.
3. Coran, A. Y., Chapter 7—Vulcanization. In The Science and Technology of Rubber (Fourth Edition), Mark, J. E.; Erman, B.; Roland, C. M., Eds. Academic Press: Boston, 2013; pp 337-381.
4. Rubber Recycling: Challenges and Developments. RSC: 2019.
5. Stevenson, K.; Stallwood, B.; Hart, A. G., Tire Rubber Recycling and Bioremediation: A Review. Bioremediation J. 2008, 12 (1), 1-11.
6. Czajczynska, D.; Krzyżyńska, R.; Jouhara, H.; Spencer, N., Use of pyrolytic gas from waste tire as a fuel: A review. Energy 2017, 134, 1121-1131.
7. Benson, S. W., Thermochemistry and kinetics of sulfur-containing molecules and radicals. Chem. Rev. 1978, 78 (1), 23-35.
8. Studebaker, M. L.; Nabors, L. G., Sulfur Group Analyses in Natural Rubber Vulcanizates. Rubber Chem. Tech. 1959, 32 (4), 941-961.
9. Studebaker, M. L., Lithium Aluminum Hydride Analysis of Sulfur-Cured Vulcanizates. Rubber Chem. Tech. 1970, 43 (3), 624-650.
10. Walvekar, R.; Afiq, Z. M.; Ramarad, S.; Khalid, S., Devulcanization of Waste Tire Rubber Using Amine Based Solvents and Ultrasonic Energy. MATEC Web Conf. 2018, 152.
11. Lukevics, E.; Dzintara, M., The alcoholysis of hydrosilanes. J. Organomet. Chem. 1985, 295 (3), 265-315.
12. Marclniec, B.; Gulinski, J.; Urbaniak, W.; Kornetka, Z. W., Comprehensive Handbook on Hydrosilylation Chemistry. Pergamon: Oxford, 1992.
13. Ballestri, M.; Chatgilialoglu, C.; Clark, K. B.; Griller, D.; Giese, B.; Kopping, B., Tris(trimethylsilyl)silane as a radical-based reducing agent in synthesis. J. Org. Chem. 1991, 56 (2), 678-683.
14. Carey, F. A.; Tremper, H. S., Carbonium ion-silane hydride transfer reactions. V. tert-Alkyl cations. J. Org. Chem. 1971, 36 (6), 758-761.
15. Brook, M. A., New Control Over Silicone Synthesis using SiH Chemistry: The Piers-Rubinsztajn Reaction. Chem. Eur. J. 2018, 24 (34), 8458-8469.
16. Gevorgyan, V.; Rubin, M.; Liu, J. X.; Yamamoto, Y., A direct reduction of aliphatic aldehyde, acyl chloride, ester, and carboxylic functions into a methyl group. J. Org. Chem. 2001, 66 (5), 1672-1675.
17. Parks, D. J.; Piers, W. E., Tris(pentafluorophenyl)boron-catalyzed hydrosilation of aromatic aldehydes, ketones, and esters. J. Am. Chem. Soc. 1996, 118 (39), 9440-9441.
18. Saito, K.; Kondo, K.; Akiyama, T., B(C₆F₅)₃-Catalyzed Hydrodesulfurization Using Hydrosilanes—Metal-Free Reduction of Sulfides. Org. Lett. 2015, 17 (13), 3366-3369.
19. Brook, M. A., Hydrosilanes as Reducing Agents. In Silicon in Organic, Organometallic and Polymer Chemistry, Wiley: New York, 2000; pp 171-188.
20. Pohlmann, J. L. W.; Brinckmann, F. E., Preparation and Characterization of Group III A Derivatives. Zeitschrift f\ddot{u}r Naturforschung B 1965, 20 (1), 5-11.
21. Stensaas, K. L.; Brownell, A. S.; Ahuja, S.; Kaiser Harriss, J.; Herman, S. R., Competitive oxidations of dibenzyl trisulfide vs. substituted aryl polysulfides. J. Sulfur Chem. 2008, 29 (3-4), 433-443.
22. Luginsland, H. D.; Röben, C., Development of sulphur-functional silanes as coupling agents in silica-reinforced rubber compounds. Their historical development over several decades. Int. Polym. Sci. Tech. 2016, 42 (4), T1-T5.
23. Standard Test Methods for Rubber Products—Chemical Analysis. ASTM 2002, D, 297-93.
24. Jakab, E.; Omastová, M., Thermal decomposition of polyolefin/carbon black composites. J. Anal. Appl. Pyrolysis 2005, 74 (1), 204-214.
25. Brazier, D. W.; Nickel, G. H., Thermoanalytical Methods in Vulcanizate Analysis II. Derivative Thermogravimetric Analysis. Rubber Chem. Tech. 1975, 48 (4), 661-677.
26. Standard Test Method for Rubber—Compositional Analysis by Thermogravimetry (TGA). ASTM 2014, D6370-99.
27. Piers, W. E.; Chivers, T., Pentafluorophenylboranes: from obscurity to applications. Chem. Soc. Rev. 1997, 26 (5), 345-354.

1. A process for cleaving one or more S—S and/or S—H bonds in one or more organic compounds, comprising combining the one or more organic compounds with one or more hydrosilanes and a catalyst to form a reaction mixture and treating the reaction mixture under conditions to cleave one or more of the S—S and/or S—H bonds.

2. A process for cleaving one or more S—S and/or S—H bonds in one or more organic compounds, comprising combining the one or more organic compounds with one or more hydrosilanes to form a reaction mixture and treating the reaction mixture under conditions to cleave one or more of the S—S and/or S—H bonds.

3. The process of claim 1 or 2, wherein the conditions to cleave the one or more of the S—S and/or S—H bonds comprises a reaction temperature of about 20° C. to about 130° C.

4. The process of claim 1 or 2, wherein the conditions to cleave the one or more of the S—S and/or S—H bonds comprises a reaction temperature of about 20° C. to about 100° C.

5. The process of claim 1 or 2, wherein the conditions to cleave the one or more of the S—S and/or S—H bonds comprises a reaction temperature of below about 80° C.

6. The process of any one of claims 1 to 5, wherein the one or more organic compounds are selected from one or more sulfur-containing silyl coupling agents.

7. The process of claim 6, wherein the one or more sulfur-containing silyl coupling agents are selected from compounds of Formula I: 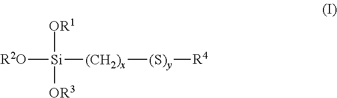
wherein
R¹, R² and R³ are independently selected from C₁₋₁₀alkyl, C₂₋₁₀alkenyl, C₁₋₆alkylenearyl, aryl, linear silicones and branched silicones,
R⁴ is selected from H and 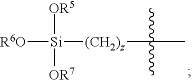
R⁵, R⁶ and R⁷ are independently selected from C₁₋₁₀alkyl, C₂₋₁₀alkenyl, C₁₋₆alkylenearyl, aryl, linear silicones and branched silicones;
x and z are independently 1, 2, 3, 4, 5 or 6; and
y is 1, 2, 3, 4, 5, 6, 7 or 8, provided that when y is 1, R⁴ is H.

8. The process of claim 7, wherein R¹, R² and R³ are independently selected from C₁₋₄alkyl, C₂₋₄alkenyl, C₁₋₂alkylenearyl, aryl, linear silicones and branched silicones.

9. The process of claim 8, wherein R¹, R² and R³ are the same and are CH₃, CH₃CH₂, (CH₃)₂CH, CH₃CH₂CH₂, CH₂═CHCH₂ or PhCH₂.

10. The process of any one of claims 7 to 9, wherein R⁴ is

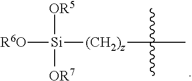

11. The process of claim 10, wherein R⁵, R⁶ and R⁷ are independently selected from C₁₋₄alkyl, C₂₋₄alkenyl, C₁₋₂alkylenearyl, aryl, linear silicones and branched silicones.

12. The process of claim 11, wherein R⁵, R⁶ and R⁷ are the same and are CH₃, CH₃CH₂, (CH₃)₂CH, CH₃CH₂CH₂, CH₂═CHCH₂ or PhCH₂.

13. The process of any one of claims 7 to 12, wherein x and z are independently 3 or 4.

14. The process of claim 7, wherein the one or more compounds of Formula I are selected from: 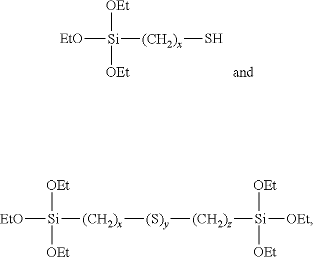
wherein each x and z is independently 3 or 4, suitably 3 and y is selected from 2, 3, 4, 5 and 6.

15. The process of any one of claims 1 to 5, wherein the one or more organic compounds are one or more organopolysulfides.

16. The process of claim 15, wherein the one or more organopolysulfides are selected from one or more sulfur-cured elastomers.

17. The process of claim 16, wherein the one or more sulfur-cured elastomers is a crosslinked polyolefin.

18. The process of claim 17, wherein the one or more sulfur-cured elastomers is a polyisobutylene, polyisoprene, natural rubber or polybutadiene, or a copolymer thereof.

19. The process of any one of claims 1 to 18, wherein the one or more hydrosilanes are selected from compounds of Formula II: 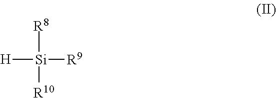
wherein
R⁸, R⁹ and R¹⁰ are independently selected from H, halo, C₁₋₁₀alkyl, C₁₋₁₀alkoxy, aryl, C₁₋₂alkylenearyl, C₁₋₆alkoxy-substituted C₁₋₁₀alkyl, C₁₋₆alkoxy-substituted aryl, linear silicones and branched silicones, provided that at least one of R⁸, R⁹ and R¹⁰ is other than H.

20. The process of any one of claims 1 to 19, wherein the one or more hydrosilanes are selected from compounds of Formula III 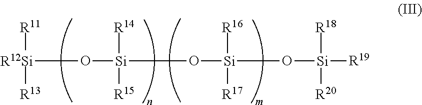
wherein
R¹¹, R¹², R¹³, R¹⁴, R¹⁵, R¹⁶, R¹⁷, R¹⁸, R¹⁹ and R²⁰ are independently selected from H, halo, C₁₋₁₀alkyl, C₁₋₁₀alkoxy, aryl, C₁₋₂alkylenearyl, fluoro-substituted C₁₋₁₀alkyl, C₁₋₆alkoxy-substituted C₁₋₁₀alkyl, fluoro-substituted aryl and C₁₋₆alkoxy-substituted aryl, provided that
R¹² is H, and R¹¹, R¹³, R¹⁴, R¹⁵, R¹⁶, R¹⁷, R¹⁸, R¹⁹ and R²⁰ are other than H,
R¹² and R¹⁹ are H, and R¹¹, R¹³, R¹⁴, R¹⁵, R¹⁶, R¹⁷, R¹⁸ and R²⁰ are other than H, or
R¹⁴ is H and R¹¹, R¹³, R¹⁵, R¹⁶, R¹⁷, R¹⁸ and R²⁰ are other than H, or
R¹⁶ is H and R¹¹, R¹³, R¹⁴, R¹⁵, R¹⁷, R¹⁸ and R²⁰ are other than H; and
n and m are independently 0, 2, 3, 4, 5, 6, 7, 8, 9, or 10-1000.

21. The process of any one of claims 1 to 19, wherein the one or more hydrosilanes are selected from compounds of Formula III 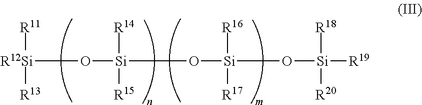
wherein
R¹¹, R¹², R¹³, R¹⁴, R¹⁵, R¹⁶, R¹⁷, R¹⁸, R¹⁹ and R²⁰ are independently selected from H, halo, C₁₋₁₀alkyl, C₁₋₁₀alkoxy, aryl, C₁₋₂alkylenearyl, fluoro-substituted C₁₋₁₀alkyl, C₁₋₆alkoxy-substituted C₁₋₁₀alkyl, fluoro-substituted aryl and C₁₋₆alkoxy-substituted aryl, provided that
R¹² is H, and R¹¹, R¹³, R¹⁴, R¹⁵, R¹⁶, R¹⁷, R¹⁸, R¹⁹ and R²⁰ are other than H,
R¹² and R¹⁹ are H, and R¹¹, R¹³, R¹⁴, R¹⁵, R¹⁶, R¹⁷, R¹⁸ and R²⁰ are other than H, or
R¹⁴ is H and R¹¹, R¹³, R¹⁵, R¹⁶, R¹⁷, R¹⁸ and R²⁰ are other than H, or
R¹⁶ is H and R¹¹, R¹³, R¹⁴, R¹⁵, R¹⁷, R¹⁸ and R²⁰ are other than H; and
n and m are independently 0, 2, 3, 4, 5, 6, 7, 8, 9 or 10.

22. The process of claim 21, wherein the compounds of Formula III are selected from one or more of 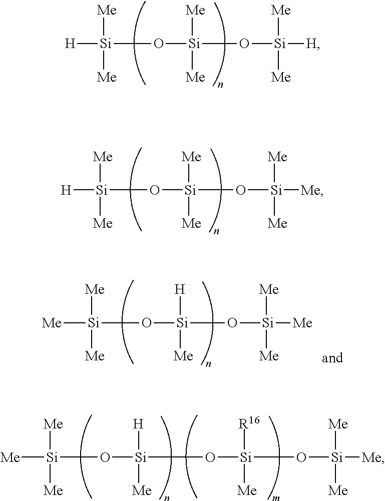
wherein R¹⁶ is C₁₋₆alkyl or aryl, each n is independently 0, 1, 2,3, 4, 5 or 6 and m is 0, 1, 2, 3, 4, 5 or 6.

23. The process of claim 22, wherein the hydrosilane is

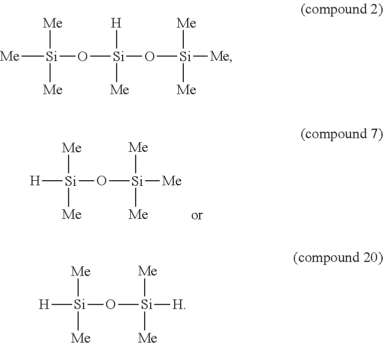

24. The process of any one of claims 1 to 19, wherein the one or more hydrosilanes are cyclic hydrosilanes, such as cyclic siloxanes, including, but not limited to tetramethylcyclotetrasiloxane and pentamethylcyclopentasiloxane.

25. The process of any one of claims 1 to 24, wherein the S—S and/or S—H bonds in the one or more organic compounds are reductively cleaved.

26. The process of any one of claims 1 to 25, wherein the one or more hydrosilanes are present in an amount from about 2:1 to about 5:1 equivalents relative to the S—S and/or S—H bond content in the one or more organic compounds.

27. The process of any one of claims 1 to 26, wherein the catalyst, when present, is a Lewis acid.

28. The process of claim 27, wherein the Lewis acid catalyst comprises boron.

29. The process of claim 28, wherein the catalyst is B(C₆F₅)₃.

30. The process of any one of claims 1 to 29, wherein the catalyst, when present, is present in an amount of about 0.01 mol % to about 5 mol %.

31. A method for de-crosslinking one or more sulfur-crosslinked elastomers comprising combining the one or more sulfur-crosslinked elastomers with one or more hydrosilanes and a catalyst to form a reaction mixture and treating the reaction mixture under conditions to decrosslink the sulfur-crosslinked elastomers.

32. A method for de-crosslinking one or more sulfur-crosslinked elastomers comprising combining the one or more sulfur-crosslinked elastomers with one or more hydrosilanes to form a reaction mixture and treating the reaction mixture under conditions to decrosslink the sulfur-crosslinked elastomers.

33. The method of claim 31 or 32, wherein the one or more sulfur-crosslinked elastomers are rubbers used in tires.

34. The method of claim 33, wherein the tires are automotive tires or industrial tires, or the rubbers are bicycle inner tubes.

35. The method of any one of claims 31 to 33, wherein the elastomers or rubbers are treated prior to combining with the one or more hydrosilanes, for example to form into a crumb and/or to extract extractible components with solvents such as acetone.

36. The process of any one of claims 1 to 30, wherein the process produces silylated sulfur-containing compounds.

37. The process of claim 36, further comprising separating the silylated sulfur-containing compounds from and solid or inorganic materials that may have been present in the one or more organic compounds.

38. The process of claim 37, wherein the solid or inorganic materials are selected from unreactive solids such as fillers, fiber and metal reinforcements, and pigments.

39. The process of claim 37 or 38, wherein the solid or inorganic materials are separated by filtration and/or centrifugation.

40. The process of any one of claims 36 to 39, wherein the silylated sulfur-containing compounds are desilylated, for example by treatment with fluoride, to provide the corresponding thiols, which are optionally re-oxidized to provide other S—S containing compounds.

41. De-crosslinked sulfur-crosslinked elastomers prepared using the method of any one of claims 31 to 35.
